(19) United States
(12) Patent Application Publication
(10) Pub. No.: US 2009/0009772 A1
(43) Pub. Date: Jan. 8, 2009

(54) OPTICAL MEASURING APPARATUS AND OPTICAL MEASURING METHOD

(75) Inventor: Kazunori Tanimura, Tokyo (JP)

Correspondence Address: SUGHRUE-265550, 2100 PENNSYLVANIA AVE. NW, WASHINGTON, DC, 20037-3213, US

(73) Assignee: YOKOGAWA ELECTRIC CORPORATION, Musashino-shi (JP)

(21) Appl. No.: 12/136,491

(22) Filed: Jun. 10, 2008

(30) Foreign Application Priority Data
Jun. 11, 2007 (JP) 2007-153649

(51) Int. Cl. G01B 9/02

(52) U.S. Cl. 356/491

(57) ABSTRACT

An optical measuring apparatus, includes an optical branch element for splitting a measured light into plural lights, a time delay processing portion for giving a predetermined time delay to one split light of the measured light, an optical phase diversity circuit for outputting an in-phase signal component and an quadrature-phase signal component of the measured light by virtue of an interference between the measured light and a reference light between which a relative time difference corresponds to a time give by the time delay, while using other split light of the measured light or the measured light to which a process is applied by the time delay processing portion as the reference light, a data processing circuit for calculating at least one of an amount of change of an amplitude and an amount of change of a phase of the measured light, based on the in-phase signal component and the quadrature-phase signal component, and an optical time gate processing portion or an electric time gate processing portion provided on a route extending from the optical branch element to the data processing circuit, for extracting at least one of split lights of the measured light every predetermined bit time while shifting a timing, wherein changes of amplitude/phase distributions in time are measured.

This application claims priority to Japanese Patent Application No. 2007-153649, filed Jun. 11, 2007, in the Japanese Patent Office. The Japanese Patent Application No. 2007-153649 is incorporated by reference in its entirety.

### TECHNICAL FIELD

The present disclosure relates to an optical measuring apparatus and an optical measuring method for measuring a time change in amplitude/phase distributions of a light signal.

### RELATED ART

Recent years, as the transmission signal used in the optical communication, the phase modulation system in which information are added to a phase of a light as well as the intensity modulation system in the related art has been proposed. As the digital phase modulation system, there are BPSK (Binary Phase Shift-Keying) in which binary digital values are correlated with 0, π the optical phase, DPSK (Differential Phase Shift-Keying) in which digital values are discriminated based on a phase difference between adjacent bits, and the like, for example. Also, the multilevel modulation systems such as APSK (Amplitude Phase Shift-Keying) in which the digital value is added to both the amplitude and the phase, and the like have been proposed. With the progress of research on such phase modulation system, the need for an apparatus and approach for measuring quantitatively a phase of the light is increasing.

The optical measuring approach proposed in Non-Patent Literature 1 will be explained with reference to FIG. 27 to FIG. 29 hereunder. As shown in FIG. 27, the optical measuring system shown in Non-Patent Literature 1 is constructed by a sampling laser 301 for generating a sampling light, a light signal generating device 302 for generating a measured light, a trigger signal generator 303, an optical band-pass filter 304, a polarization controller 305 for controlling a polarization of the measured light, an optical phase diversity circuit 306, differential photodetectors 307, 308, and an AD converter 309. The trigger signal generator 303 generates a trigger signal to synchronize the sampling laser 301 with the AD converter 309.

The optical measuring system shown in Non-Patent Literature 1 samples and plots sequentially the amplitude and the phase of the measured light based on the amplitude and the phase of the sampling light being oscillated stably, by using the optical phase diversity circuit 306 shown in FIG. 27. A configuration of the optical phase diversity circuit 306 is shown in FIG. 28. The sampling light and the measured light being input into the optical phase diversity circuit 306 are split by splitters S_{S} and S_{D} respectively, and are coupled by couplers C_{A} and C_{B}. When a phase difference of π/2 is added to one sampling light being split by the splitter S_{S} by a phase adjuster 310, interference signals corresponding to the in-phase signal component and the quadrature-phase signal component of the optoelectric field of the input measured light are acquired by differential photodetectors S_{A} and S_{B} respectively based on the amplitude and the phase of the sampling light.

The optoelectric field e_{D}(t) of the measured light and the optoelectric field e_{S}(t) of the sampling light are given by Equation (1) and Equation (2) respectively.

[Formula 1]

e_{D}(t)=E_{D}(t)exp [−iω_{D}t+iφ(t)+iψ] (1)

[Formula 2]

e_{S}(t)=E_{S}(t)exp [−iω_{S}t] (2)

where ω_{D} is an optical carrier frequency of the measured light, and ω_{S} is an optical carrier frequency of the sampling light. In Equation (1), E_{D}(t) denotes an envelop of the optoelectric field of the measured light, φ(t) denotes a phase change of the carrier wave in time, and Ψ denotes an initial phase (relative phase to the sampling light). When the measured light is the phase modulation signal, φ(t) has a different value every bit, and a change of φ(t) becomes the measured object. In Equation (2), E_{S}(t) denotes an envelope of the optoelectric field of the sampling light.

The N-th sampling data acquired when the interference signals S_{A} and S_{B} obtained by using the optical phase diversity circuit 306 are sampled every period T are given by Equation (3) and Equation (4) respectively.

[Formula 3]

s_{A}(NT)=2·\sqrt{P}·E_{D}(NT)·cos [−(ω_{D}−ω_{S})NT+φ(NT)+ψ] (3)

[Formula 4]

s_{B}(NT)=2·\sqrt{P}·E_{D}(NT)·sin [−(ω_{D}−ω_{S})NT+φ(NT)+ψ] (4)

where the sampling light is approximated by the delta function, and P is an intensity of the sampling light.

Therefore, a magnitude of the interference signal is reflective of the amplitude E_{D}(t) and the phase φ(t) at the sampling point of the measured light. As a result, an amount of change of the amplitude and an amount of change of the phase of the measured light (an amount of change of E_{D}(t) and an amount of change of φ(t)) can be measured by analyzing the acquired sampling data represented by Equation (3) and Equation (4).

An example of amplitude/phase distributions in which an amount of change of the amplitude and an amount of change or the phase are represented in the polar coordinates is shown in FIG. 29. As shown in FIG. 29, the amplitude/phase distributions can be obtained by plotting a magnitude S_{A} (NT) of the in-phase signal component on the x coordinate and plotting a magnitude S_{B} (NT) of the quadrature-phase signal component on the y coordinate at respective sampling points.
[Non-Patent Literature 1] C. Dorrer, Christopher Richard Doerr, I. Kang, Roland Ryf, J. Leuthold, P. J. Winzer, “Measurement of Eye Diagrams and Constellation Diagrams or Optical Sources Using Linear Optics and Waveguide Technology” Journal of Lightwave Technology, Vol. 23, No. 1, January 2005, pp. 178-186.

The above measuring approach in the related art employs the sampling approach, but is basically executed based on the optical heterodyne measurement. Normally the optical phase measuring approach based on the optical heterodyne measurement is easily affected by fluctuation of a wavelength of the local oscillation light (sampling light), and therefore a stable light source equipped with the feedback mechanism, or the like must be prepared. Also, in order to obtain the interference signal by using the optical phase diversity circuit, respective wavelengths of the measured light and the local oscillation light must be set to the substantially same extent. As a result, such a problem exists in the measuring approach in the related art that a range of the measured wavelength is limited depending upon the light source.

Also, an amount of change of the intensity (an amount of change of the amplitude) of the light signal can be measured by utilizing the waveform measuring instrument such as the optical oscilloscope, or the like, but it is not easy to measure an amount of change of the phase. It seems that the approach using the optical phase diversity circuit, as described above, is effective as the approach of measuring an amount of change of the phase. However, the local oscillation light must be prepared in the approach in the related art, so that the measured object and the measured accuracy depend greatly upon the performance of the light source.

### SUMMARY

Exemplary embodiments of the present invention provide an optical measuring apparatus and an optical measuring method capable of measuring an amount of change of the amplitude and an amount of change of the phase of a light signal without use of a local oscillation light.

In order to solve the above problem, the first invention provides an optical measuring apparatus, which includes an optical branch element for splitting a measured light into plural lights; a time delay processing portion for giving a predetermined time delay to one split light of the measured light; an optical phase diversity circuit for outputting an in-phase signal component and an quadrature-phase signal component of the measured light by virtue of an interference between the measured light and a reference light between which a relative time difference corresponds to a time give by the time delay, while using other split light of the measured light or the measured light to which a process is applied by the time delay processing portion as the reference light; a data processing circuit for calculating at least one of an amount of change of an amplitude and an amount of change of a phase of the measured light, based on the in-phase signal component and the quadrature-phase signal component; and an optical time gate processing portion or an electric time gate processing portion provided on a route extending from the optical branch element to the data processing circuit, for extracting at least one of split lights of the measured light every predetermined bit time while shifting a timing; wherein changes of amplitude/phase distributions in time are measured.

In the second invention, the optical measuring apparatus according to the first invention further includes a frequency shifter for shifting an optical carrier frequency of one split light of the measured light.

In the third invention, the optical measuring apparatus according to the first or second invention further includes an optical clock recovery circuit for generating a clock signal in synchronism with the measured light.

In the fourth invention, in the optical measuring apparatus according to the first or second invention, a light signal on which a pseudo-random code is superposed is used as the measured light, and the data processing circuit executes a data processing by using a frame signal that is synchronized with a repetitive frequency of the pseudo-random code.

In the fifth invention, the optical measuring apparatus according to the first or second invention further includes a polarization isolating element for separating the measured light into a plurality of polarization components that intersect orthogonally with each other; wherein processes made by the optical branch element, the time delay processing portion, and the optical phase diversity circuit are applied to respective polarization components that are separated by the polarization isolating element.

In the sixth invention, the optical measuring apparatus according to the first or second invention further includes a measuring section for measuring an intensity of at least one of the measured light and the reference light.

In the seventh invention, the optical measuring apparatus according to the first or second invention further includes a display portion for displaying amplitude/phase distributions of the measured light, based on a processed result of the data processing circuit.

Also, the eighth invention provides an optical measuring method, which includes a step of splitting a measured light into plural lights; a step of giving a predetermined time delay to one split light of the measured light; a step of outputting an in-phase signal component and an quadrature-phase signal component of the measured light by virtue of an interference between the measured light and a reference light between which a relative time difference corresponds to a time give by the time delay, while using other split light of the measured light or the measured light to which a process is applied by the time delay processing portion as the reference light; a step of calculating at least one of an amount of change of an amplitude and an amount of change of a phase of the measured light, based on the in-phase signal component and the quadrature-phase signal component; and a step of measuring changes of amplitude/phase distributions in time by extracting at least one of split lights of the measured light every predetermined bit time while shifting a timing.

According to the present invention, an amount of change of the amplitude and an amount of change of the phase of the measured light can be measured not to use the local oscillation light. In particular, since the optical time gate processing portion or the electric time gate processing portion is employed, an amount of change of the amplitude and an amount of change of the phase of the measured light can be measured by using the AD converter and the data processing circuit whose operating frequency band is low. Also, since at least one split light of the measured light is extracted every predetermined bit time while shifting a timing, changes of amplitude/phase distributions in time are measured.

Also, the clock signal is generated in synchronism with the measured light by the optical clock recovery circuit. Therefore, an amount of change of the amplitude and an amount of change of the phase of the measured light can be measured without the external clock signal.

Also, the light signal on which a pseudo-random code is superposed is used as the measured light. Therefore, the data processing can be executed by using the frame signal that is synchronized with the repetitive frequency of the pseudo-random code, and a behavior of the amplitude change and the phase change of the measured light every bit can be measured.

Also, the split measured light and the measured light to which a time delay is given are multiplexed together, and the process of the optical time gate processing portion is applied collectively to the multiplexed measured light. Therefore, only the signal necessary for the data acquisition can be input into the optical phase diversity circuit, and a noise reduction in receiving the light can be attained.

Also, different bits are extracted from respective split measured lights. Therefore, only the signal necessary for the data acquisition can be input into the optical phase diversity circuit, and a noise reduction in receiving the light can be attained.

Also, the measured light is separated into plural polarization components that intersect orthogonally with each other, by using the polarization isolating element. Then, the amplitude measurement and the phase measurement of respective polarization components can be made independently.

Also, an intensity of the measured light or the reference light is measured separately from the amplitude/phase measurement and is used in the data processing. Therefore, improvement of a measuring accuracy can be attained.

Also, changes in time of the amplitude/phase distributions of the measured light are displayed. Therefore, a quality of the measured light can be evaluated in a time domain.

Also, the electric signal involving the cosine (sine) oscillation can be obtained steadily from the optical phase diversity circuit. Therefore, the components whose low frequency characteristic is poor (which does not correspond to the DC component) can be used in the electric circuit. Also, a choice of the available components is widened. Therefore, improvement of the performance such as a measuring accuracy, a measuring sensitivity, or the like can be expected.

Other features and advantages may be apparent from the following detailed description, the accompanying drawings and the claims.

### BRIEF DESCRIPTION OF THE DRAWINGS

FIG. 1 is a block diagram showing an internal configuration of an optical measuring apparatus according to Embodiment 1 of the present invention.

FIG. 2 is a view showing an example of an internal configuration of a waveguide-type optical phase diversity circuit.

FIG. 3 is a view showing a time chart of an operation of the optical measuring apparatus according to Embodiment 1.

FIG. 4 is a view showing an example of amplitude/phase/time distributions of a DPSK signal.

FIG. 5 is a view showing an example of an internal configuration of an optical phase diversity circuit using a spatial system optical element.

FIG. 6 is a view showing another example of the internal configuration of the optical phase diversity circuit using the spatial system optical element.

FIG. 7 is a view showing still another example of the internal configuration of the optical phase diversity circuit using the spatial system optical element.

FIG. 8 is a block diagram showing an internal configuration of an optical measuring apparatus according to Variation 1 of Embodiment 1.

FIG. 9 is a block diagram showing an internal configuration of an optical measuring apparatus according to Variation 2 of Embodiment 1.

FIG. 10 is a block diagram showing an internal configuration of an optical measuring apparatus according to Variation 3 of Embodiment 1.

FIG. 11 is a block diagram showing an internal configuration of an optical measuring apparatus according to Variation 4 of Embodiment 1.

FIG. 12 is a block diagram showing an internal configuration of an optical measuring apparatus according to Variation 5 of Embodiment 1.

FIG. 13 is a block diagram showing an internal configuration of an optical measuring apparatus according to Variation 6 of Embodiment 1.

FIG. 14 is a block diagram showing an internal configuration of an optical measuring apparatus according to Variation 7 of Embodiment 1.

FIG. 15 is a view showing a display example of amplitude/phase distributions when loci of amplitude and phase changes of a light are displayed dynamically.

FIG. 16 is a block diagram showing an internal configuration of an optical measuring apparatus according to Variation 8 of Embodiment 1.

FIG. 17 is a block diagram showing an internal configuration of an optical measuring apparatus according to Embodiment 2 of the present invention.

FIG. 18 is a view showing a time chart of an operation of the optical measuring apparatus according to Embodiment 2.

FIG. 19 is a view showing an example of an element having both functions of a time delay processing portion and an optical phase diversity circuit together.

FIG. 20 is a block diagram showing an internal configuration of an optical measuring apparatus according to Embodiment 3 of the present invention.

FIG. 21 is a view showing a time chart of an operation of the optical measuring apparatus according to Embodiment 3.

FIG. 22 is a view showing acquisition of amplitude/phase distributions by the data processing.

FIG. 23 is a block diagram showing an internal configuration of an optical measuring apparatus according to Variation 1 of Embodiment 3.

FIG. 24 is a block diagram showing an internal configuration of an optical measuring apparatus according to Variation 2 of Embodiment 3.

FIG. 25 is a block diagram showing an internal configuration of an optical measuring apparatus according to Variation 3 of Embodiment 3.

FIG. 26 in a block diagram showing an internal configuration of an optical measuring apparatus according to Variation 4 of Embodiment 3.

FIG. 27 is a view showing a configuration of an optical measuring system in the related art.

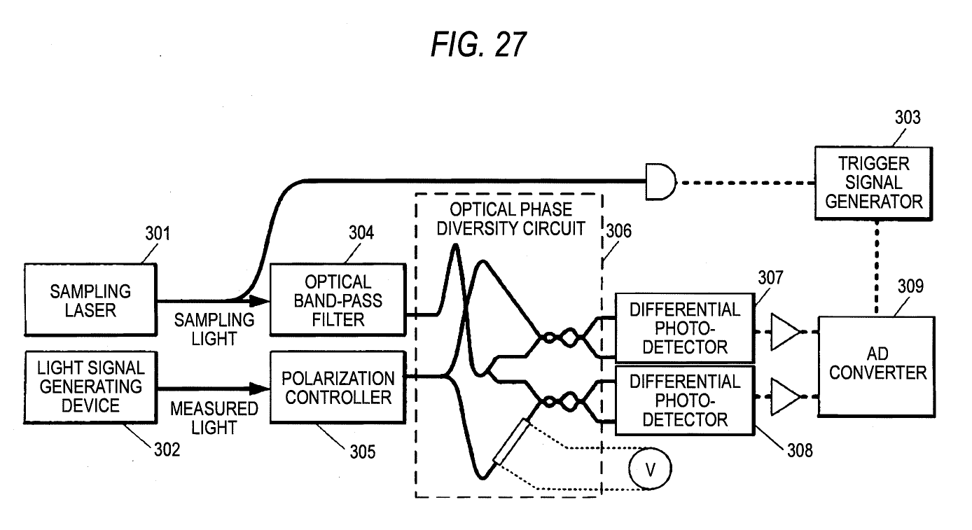

FIG. 28 is a view showing a configuration of an optical phase diversity circuit in FIG. 27.

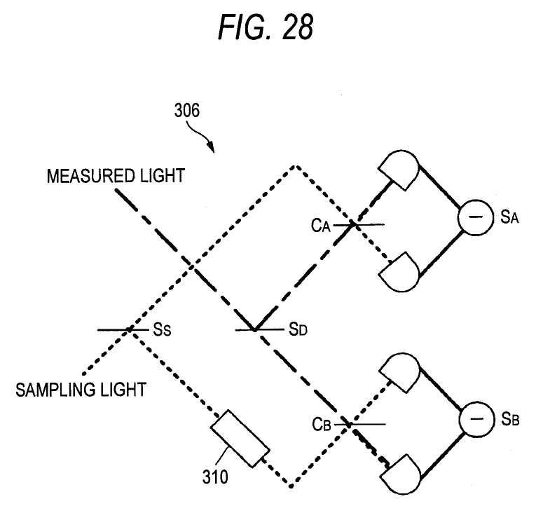

FIG. 29 is a view showing an example of amplitude/phase distributions.

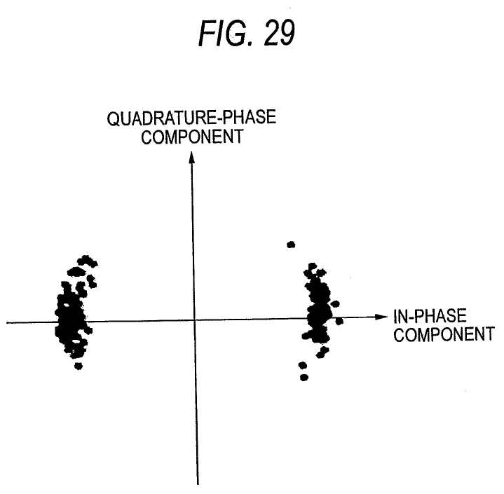

### DETAILED DESCRIPTION

The present invention will be explained with reference to the drawings hereinafter.

### Embodiment 1

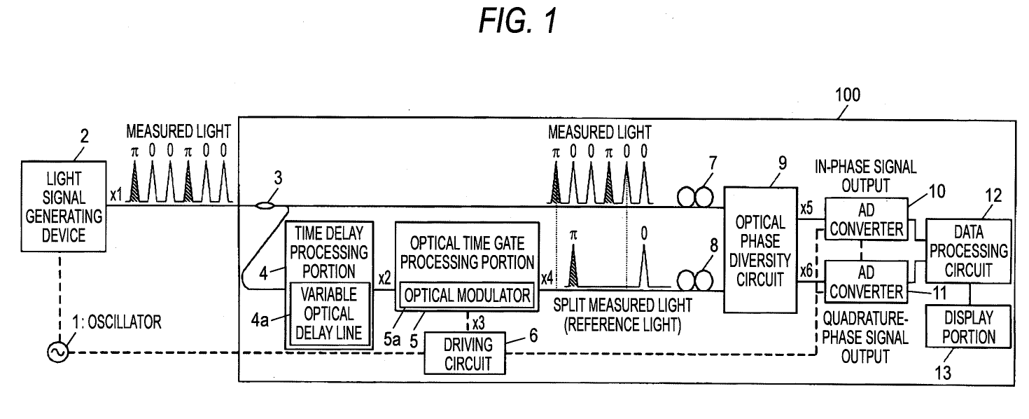

Embodiment 1 of the present invention will be explained with reference to FIG. 1 to FIG. 16 hereunder.

An internal configuration of an optical measuring apparatus 100 according to Embodiment 1 and an oscillator 1 and a light signal generating device 2 are shown in FIG. 1.

The oscillator 1 outputs an electric clock signal, which is in synchronism with the measured light generated by the light signal generating device 2, to the light signal generating device 2 and a driving circuit 6 of the optical measuring apparatus 100.

On the assumption that data propagating through the actual transmission line should be superposed on the light signal, the light signal generating device 2 generates the measured light on which random data is superposed, in synchronism with the electric clock signal that is input from the oscillator 1. As the measured light on which the random data are superposed, there is the light signal that is modulated by the DPSK system, for example.

As shown in FIG. 1, the optical measuring apparatus 100 is constructed by an optical branch element 3, a time delay processing portion 4, an optical time gate processing portion 5, the driving circuit 6, polarization controllers 7, 8, an optical phase diversity circuit 9, AD converters 10, 11, a data processing circuit 12, a display portion 13, and the like.

The optical branch element 3 split the measured light being input from the light signal generating device 2 into two lights.

The time delay processing portion 4 has a variable optical delay line 4a, and gives a time delay to one measured light split by the optical branch element 3. The time delay processing portion 4 adjusts a delay time of the variable optical delay line 4a such that a relative time difference between the measured light being input into the optical phase diversity circuit 9 and a reference light (described later) corresponds to a m-bit time (m is an integer).

The optical time gate processing portion 5 is constructed by a electro-absorption optical modulator 5a, for example, and extracts one measured light split by the optical branch element 3 every n bit time (n is an integer), while shifting a timing by a phase-shifting means (not shown). The light signal processed by the optical time gate processing portion 5 will be referred to as the “reference light” or a “split measured light” hereinafter. In this case, in the optical measuring apparatus 100 shown in FIG. 1, such an example is illustrated that the time delay processing portion 4 is arranged at the prior stage of the optical time gate processing portion 5 and an optical time gate processing is applied to the measured light to which a time delay is given by the time delay processing portion 4. But the time delay processing portion 4 may be arranged at the later stage of the optical time gate processing portion 5.

The driving circuit 6 generates a driving signal whose period is longer than a repetition period of the measured light, based on the electric clock signal input from the oscillator 1. Then, the driving circuit 6 drives the optical modulator 5a of the optical time gate processing portion 5 by this driving signal. Also, the driving circuit 6 outputs the driving signal to the AD converters 10 and 11.

The polarization controller 7 adjusts the polarization of the other measured light split by the optical branch element 3. The polarization controller 8 adjusts the polarization of the reference light.

The optical phase diversity circuit 9 is also called the “90° optical hybrid”. The optical phase diversity circuit 9 outputs an in-phase signal component and an quadrature-phase signal component of the measured light to the AD converters 10, 11 respectively, on account of the interference between the input measured light and the reference light.

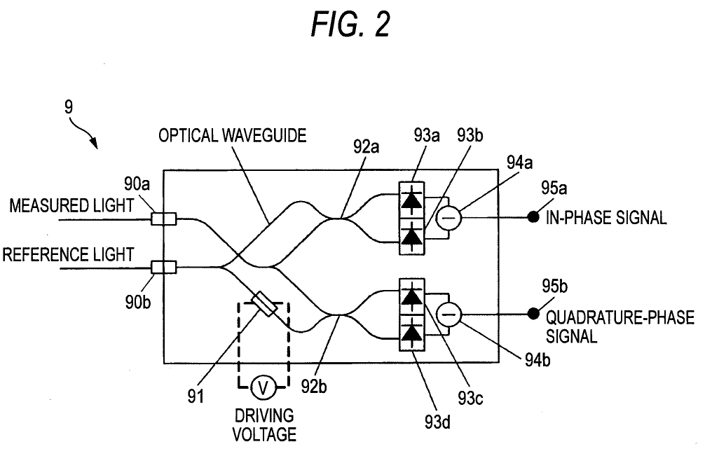

An example of an internal configuration of the optical phase diversity circuit 9 is shown in FIG. 2. The optical phase diversity circuit 9 shown in FIG. 2 is constructed by a measured light input port 90a, a reference light input port 90b, a voltage-driven phase adjuster 91, directional couplers 92a, 92b, light receiving elements 93a, 93b, 93c, 93d, differential output circuits 94a, 94b, an in-phase signal output port 95a, and an quadrature-phase signal output port 95b.

The measured light input into the measured light input port 90a is split into two lights, and the reference light input into the reference light input port 90b is also split into two lights. One split measured light is input into the directional coupler 92a and split into two lights, and then input into the light receiving elements 93a, 93b respectively. Also, one split reference light is also input into the directional coupler 92a and split into two lights, and then input into the light receiving elements 93a, 93b respectively.

In the light receiving elements 93a, 93b, the input light signal is converted into an electric signal. At this time, because the measured light input into the light receiving element 93a interferes with the reference light, an interference signal (containing a DC component) corresponding to a relative phase difference φ between them is output from the light receiving element 93a. Similarly an interference signal is output from the light receiving element 93b. In this case, the interference signal whose intensity distribution is inverted from the output signal of the light receiving element 93a is output due to the characteristic of the directional coupler 92a.

The differential output circuit 94a calculates a difference between the output signals of two light receiving elements 93a, 93b, and outputs a differential signal. Accordingly, a DC component is removed from two interference signals, and only the interference signal corresponding to a phase difference φ is output from the in-phase signal output port 95a as an electric signal.

In contrast, a phase difference of π/2 is added to the other split reference light by the phase adjuster 91, and the resultant light is input into the directional coupler 92b. Also, the other split measured light is input into the directional coupler 92b. The measured light and the reference light split by the directional coupler 92b are input into the light receiving elements 93c, 93d. The output signals from these receiving elements 93c, 93d are input into the differential output circuit 94b, and then the interference signal corresponding to a relative phase difference φ+π/2 between them is output from the quadrature-phase signal output port 95b as an electric signal.

The output signal of the differential output circuit 94a and the differential output circuit 94b give a signal component that intersects orthogonally with the phase of the measured light respectively. Therefore, one signal is acquired as the in-phase signal component and the other signal is acquired as the quadrature-phase signal component. These output signals are converted into the digital signals, and the data processing is carried out in the data processing circuit 12.

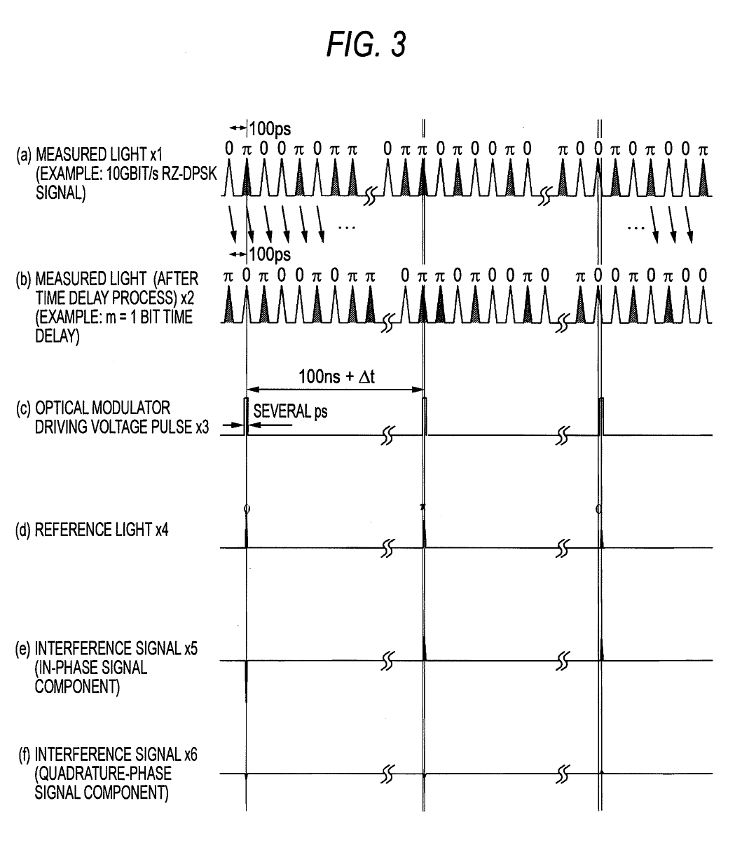

A time chart of a measured light x1 generated by the light signal generating device 2, a measured light x2 to which a time delay is given by the time delay processing portion, a driving signal (driving voltage pulse) x3 output from the driving circuit 6, a reference light x4 output from the optical time gate processing portion 5, an in-phase signal component x5 of the interference signal output from the optical phase diversity circuit 9, and an quadrature-phase signal component x6 of the interference signal output from the optical phase diversity circuit 9 is shown in FIG. 3.

As shown in FIG. 3, a RZ-DPSK signal of 10 Gbit/s (a repetition frequency is 10 GHz) is used as the measured light x1 (FIG. 3(a)). When this measured light x1 is extracted at a 1000 bit time (n=1000) (FIG. 3(d)), the driving signal of the optical modulator 5a gives a repetitive pulse train of 10 MHz (100 ns interval) (FIG. 3(c)).

In the present invention, a pulse width of this driving signal is set sufficiently shorter than a 1 bit time (e.g., 100 ps in the measured light of 10 Gbit/s) (for example, several ps), and also a repetitive period of this driving signal is set to a period (e.g., 100 ns+Δt) different from an n bit time (n is an integer) of the measured light. Concretely, the phase of the driving signal is shifted by a predetermined amount Δt (e.g., 1 ps) every predetermined bit time. This period can be decided similarly to the sampling approach (the sequential sampling, the random interleaved sampling, or the like) that is employed in the time waveform observing apparatus represented by the sampling oscilloscope, or the like.

When the optical modulator 5a of the optical time gate processing portion 5 is operated by such driving signal, the in-phase signal component (FIG. 3(e)) and the quadrature-phase signal component (FIG. 3(f)), both obtained when the gating process (the sampling process) is applied to the in-phase signal component and the quadrature-phase signal component in different m bits of the measured light in a period different from the n bit time, are input into the AD converters 10, 11 respectively. Also, when a relative time difference between the measured light x1 and the reference light x4 is 1 bit time (m=1), a relative time difference becomes 100 ps to the measured light x1 of 10 Gbit/s (FIG. 3(b)).

With such arrangement, as shown in FIGS. 3(e), (f), the interference signals (beat signals) x5, x6 between different m bits of the measured light are obtained from the optical phase diversity circuit 9 as the electric signal.

The AD converters 10, 11 convert the in-phase signal component and the quadrature-phase signal component of the measured light both being input from the optical phase diversity circuit 9 into the digital signals respectively, and output the signals to the data processing circuit 12.

The data processing circuit 12 analyzes the data input from the AD converters 10, 11, and thus calculates sequentially at least one of an amount of change of the amplitude and an amount of change of the phase in different m bits of the measured light in a repetitive period (n bit time) of the reference light. Then, the data processing circuit 12 forms amplitude/phase distributions from the resultant measured values, and calculates their changes in time. Accordingly, the observed results contain three-dimensional information of amplitude/phase/time. Three-dimensional display data of amplitude/phase/time formed in this manner are output to the display portion 13.

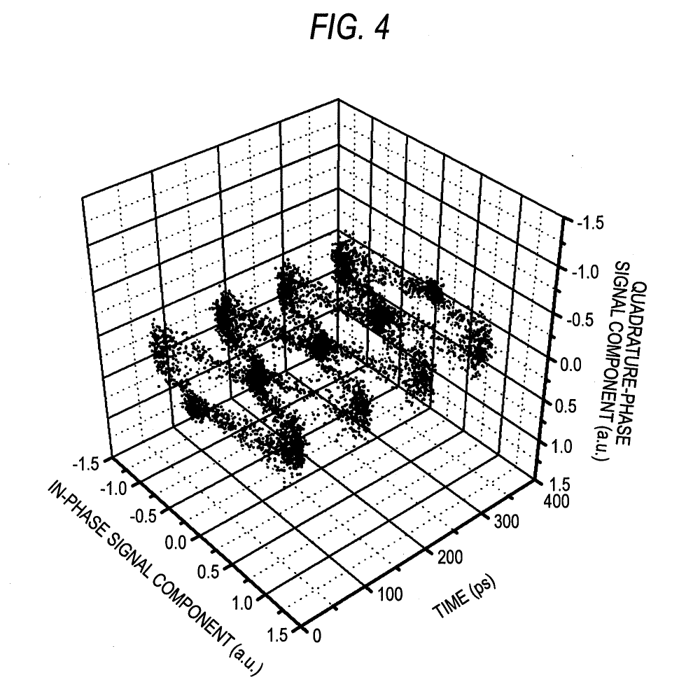

The display portion 13 is constructed by the display such as LCD (Liquid Crystal Display), and displays the processed result in the data processing circuit 12. Concretely, the display portion 13 displays three-dimensional distribution display data of amplitude/phase/time formed in the data processing circuit 12. An example of a three-dimensional distribution diagram of the RZ-DPSK signal is shown in FIG. 4. Therefore, statistical distributions of an amount of change of the amplitude and an amount of change of the phase of the measured light can be grasped from the variation of plotted data of the amplitude/phase distributions, and also their change and variation in time can be obtained. As a result, a quality evaluation of the light signal can be achieved in more detailed.

As described above, the optical measuring apparatus 100 of Embodiment 1 extracts the measured light by the optical time gate process every predetermined bits and uses one of the split measured lights as the reference light, and thus has a similar configuration to the related-art approach that likens the reference light to the sampling light. However, since this optical measuring apparatus is constructed as the self-homodyne interferometer using the measured light itself as the reference light, the interference signal can be always obtained irrespective of a wavelength of the measure light, and also the amplitude measurement and the phase measurement can always be steadily made. Also, since there is no necessity to prepare the local oscillation light (the sampling light) unlike the related art, a measuring error due to stability of the local oscillation light is never caused.

In addition, since the optical measuring apparatus 100 is constructed as the self-homodyne interferometer, the measured value is given as the relative value between the bits but an absolute value can be estimated by the numerical calculations. Also, since the optical measuring apparatus 100 is constructed similar to the delayed interferometer, such apparatus has a good matching characteristic with the differential phase modulation system that uses the delayed interferometer as the signal receiver. Therefore, this optical measuring apparatus 100 can measure the Q value of the differential phase modulation signal and measure the bit error rate.

In this event, the description contents in Embodiment 1 can be varied appropriately without departing from a gist of the present invention.

For example, the waveguide-type Mach-Zehnder modulator using the LiNbO₃ crystal can be utilized as the optical modulator employed in the optical time gate processing portion. Also, a high-speed optical switch (a switch utilizing an interference of a light, a switch utilizing absorption/transmission of an optical power, a switch utilizing reflection/transmission of an optical power, etc.) can be utilized instead of the optical modulator. Also, an external light controlled modulator/switch (using an optical Kerr shutter, a supersaturated absorber, or the like) can be utilized as the optical time gate processing portion. Also, when the process executed by the optical modulator is not enough, the used device can be constructed in a multi-stage fashion.

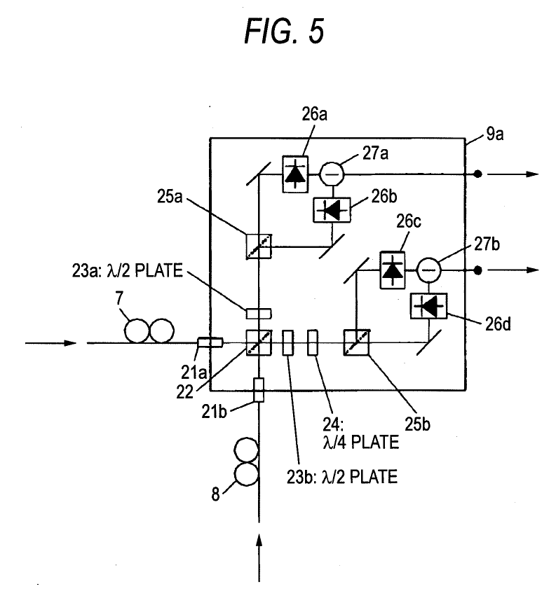

Also, in FIG. 2, the waveguide-type optical phase diversity circuit 9 is shown. But a spatial system optical element can be employed. In FIG. 5 to FIG. 7, an example of an internal configuration of the optical phase diversity circuit using the spatial system optical element is shown respectively.

In FIG. 5, an optical phase diversity circuit 9a is constructed by input ports (collimators) 21a, 21b, an optical branch element 22, λ/2 plates 23a, 23b, a λ/4 plate 24, polarization beam splitters 25a, 25b, light receiving elements 26a, 26b, 26c, 26d, and differential output circuits 27a, 27b.

The measured light input via the input port (collimator) 21a is split into two lights by the optical branch element 22. At this time, the measured light input into the optical branch element 22 is adjusted into the linear polarization in the horizontal axis direction (or the vertical axis direction) by the polarization controller 7. Because the half-wave plates (the λ/2 plates 23a and 23b) are applied to both measured lights split by the optical branch element 22 respectively, their direction of polarization is adjusted at an oblique 45° (or 135°) respectively. The measured light that is shaped into the linear polarization at an oblique 45° (or 135°) is split into two lights by the polarization beam splitters 25a, 25b respectively, and then input into the light receiving elements 26a, 26b, 26c, 26d.

In contrast, the reference light input via the input port (collimator) 21b is split into two lights by the optical branch element 22 similarly to the measured light. At this time, the reference light input the optical branch element 22 is adjusted into the linear polarization in the vertical axis direction (or the horizontal axis direction), which intersects orthogonally with the measured light, by the polarization controller 8. Because the half-wave plates (the λ/2 plates 23a and 23b) are applied to both reference lights split by the optical branch element 22 respectively, both reference lights are shaped into the linearly polarized wave whose direction of polarization is adjusted at an oblique 135° (or 45°) respectively. One reference light shaped into the oblique linearly polarized wave is split into two lights by the polarization beam splitter 25a, and then input into the light receiving elements 26a, 26b. Because the λ/4 plate 24 is arranged such that its axis direction coincides with the direction of the linear polarization of the reference light, the phase of the reference light shaped into the oblique linearly polarized wave by the λ/2 plate 23b is shifted by π/2 by the λ/4 plate 24, then is split into two lights by the polarization beam splitter 25b, and then are input into the light receiving elements 26c, 26d.

The measured light and the reference light input into the light receiving elements 26a, 26b interfere with each other, so that the interference signals (containing a DC component) corresponding to a relative phase difference φ are obtained as the output signals of the light receiving elements respectively. The interference signal obtained from the light receiving element 26a and the interference signal obtained from the light receiving element 26b act as the interference signal whose intensity distribution is inverted mutually to two outputs of the polarization beam splitter 25 a. Therefore, a DC component is removed from both interference signals by the differential output circuit 27a, and thus only the interference signal corresponding to a phase difference φ between the measured light and the reference light is obtained as the electric signal.

A relative phase difference between the measure light and the reference light being input into the light receiving elements 26c, 26d becomes φ+π/2 by an action of the λ/4 plate 24, the interference signal corresponding to the phase difference is obtained from the differential output circuit 27b. The output signal from the differential output circuit 27a and the output signal from the differential output circuit 27b give the signal components that intersect orthogonally with the phase of the measured light mutually. Therefore, one signal is acquired as the in-phase signal component and the other signal is acquired as the quadrature-phase signal component and then converted into the digital signals, and then the data processing is applied to both signals in the data processing circuit 12.

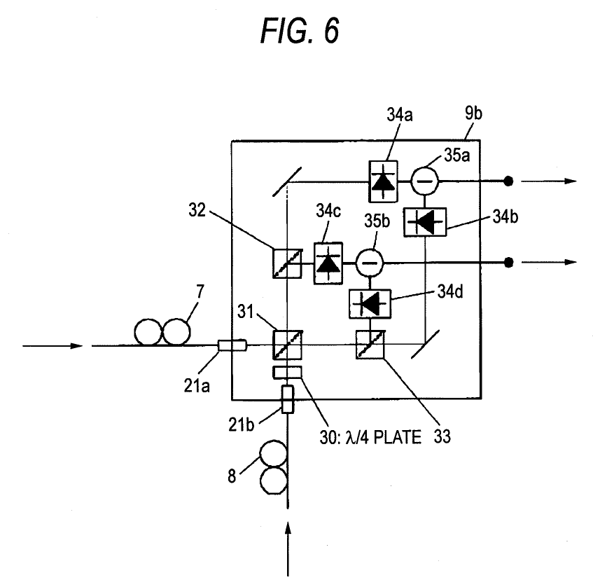

In FIG. 6, an optical phase diversity circuit 9b is constructed by the input ports (collimators) 21a, 21b, a λ/4 plate 30, an optical branch element 31, polarization beam splitters 32, 33, light receiving elements 34a, 34b, 34c, 34d, and differential output circuits 35a, 35b. The optical phase diversity circuit 9b in FIG. 6 is constructed by removing the λ/2 plates from the optical phase diversity circuit 9a in FIG. 5 and arranging the light receiving elements in different positions. The optical phase diversity circuit 9b is similar in principle to the optical phase diversity circuit 9a, and adds a phase difference to the reference light by the λ/4 plate 30. Also, both the measure light and the reference light are input as the linearly polarized wave at an oblique 45° (or 135°).

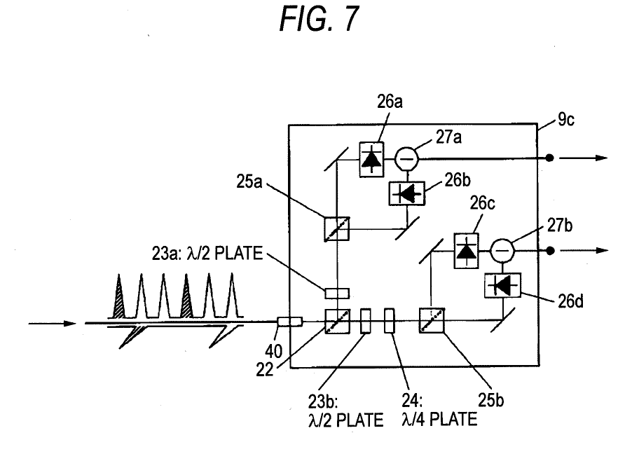

In FIG. 7, an optical phase diversity circuit 9c is constructed by integrating the input ports 21a, 21b of the optical phase diversity circuit 9a in FIG. 5 into one input port. The measure light and the reference light both propagating through the same route are prepared by adjusting the polarization in advance, and the measure light and the reference light are input as the orthogonal polarization via one input port 40 respectively.

Variations of the optical measuring apparatus 100 of Embodiment 1 will be explained hereunder.

<Variation 1>

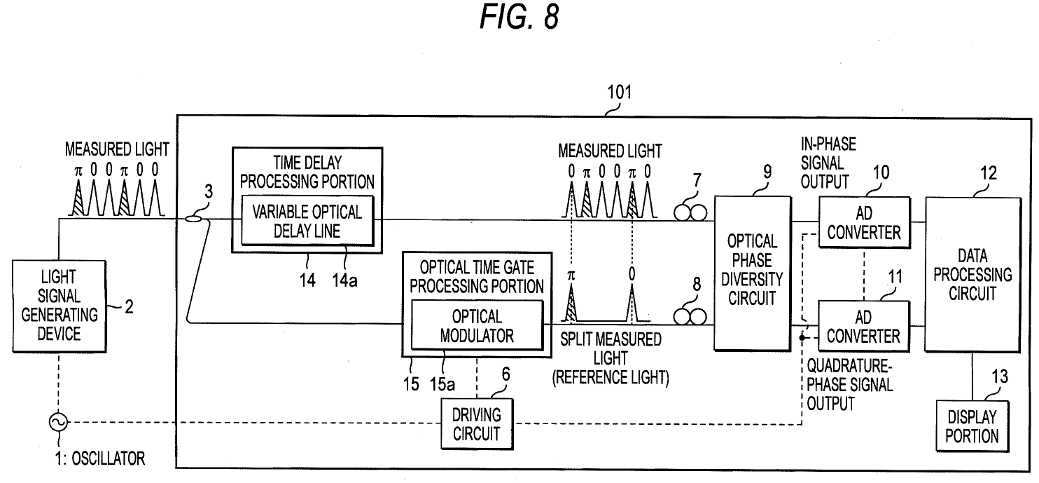

In the optical measuring apparatus 100 in FIG. 1, an example in which the time delay process and the optical time gate process are applied to one measured light being split by the optical branch element 3 is illustrated. In addition, in an optical measuring apparatus 101 in FIG. 8, the time delay may be given to one measured light being split by the optical branch element 3 by a time delay processing portion 14 having a variable optical delay line 14a, while the optical time gate process may be applied to the other split measured light by an optical time gate processing portion 15 having an optical modulator 15a.

<Variation 2>

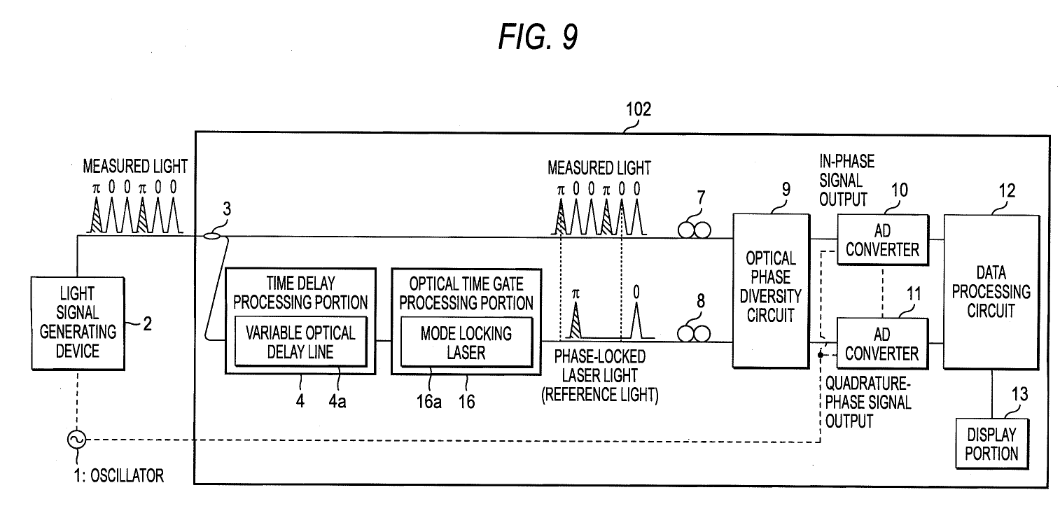

In an optical measuring apparatus 102 in FIG. 9, an optical time gate processing portion 16 executes the optical time gate process by a mode locking laser 16a. This process employs the light injection synchronizing approach using the measured light as a trigger of the laser oscillation. The laser light obtained by the light injection synchronization is put in phase with the phase of the measured light used as the trigger, and therefore this laser light can be used as the reference light.

<Variation 3>

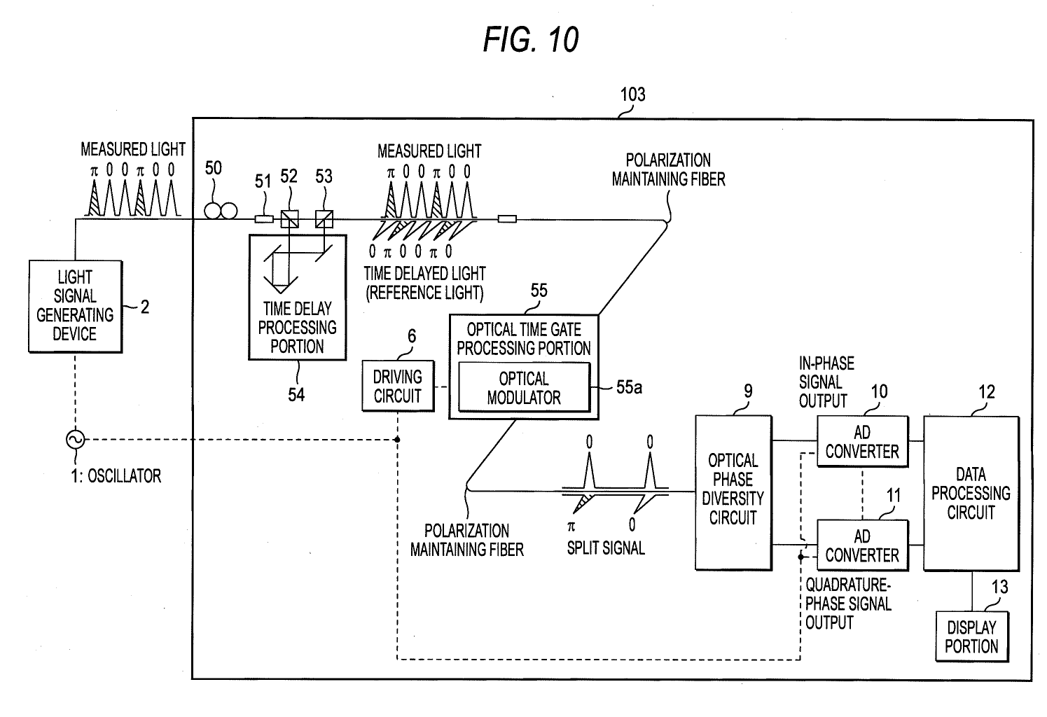

In an optical measuring apparatus 103 shown in FIG. 10, the measured light whose polarization is adjusted by a polarization controller 50 and then input via a collimator 51 is split into two lights by an optical branch element (polarization beam splitter) 52. One split measured light undergoes the time delay process from a time delay processing portion 54 with four mirrors, and then is multiplexed with the other split measured light by an optical multiplexer 53. Then, the optical time gate process is applied to the multiplexed measured light collectively by an optical time gate processing portion 55 having an optical modulator 55a.

In the optical measuring apparatus 103, the multiplexed measured light and the reference light to which a time delay is given propagate through the same polarization maintaining fiber. The polarization maintaining fiber is an optical fiber that has different propagation characteristics in the X axis and the Y axis that intersect orthogonally with the Z axis as the longitudinal direction of the optical fiber, unlike the common single mode fiber. When the linearly polarized light is input such that its polarization axis coincides with the X axis (or the Y axis) of the optical fiber, this light propagates through the optical fiber while its polarization state is maintained, and then the X-polarized (or the Y-polarized) light can be obtained from the emergent end. In the optical measuring apparatus 103, for example, the measured light and the reference light to which a time delay is given can propagate through the same polarization maintaining fiber as the X-polarized light and the Y-polarized light respectively.

In the optical measuring apparatus 103, the measured light and the reference light to which a time delay is given are extracted simultaneously by the optical time gate processing portion 55, and then only the light signal necessary for the data acquisition is input into the optical phase diversity circuit 9. Therefore, a noise generated in receiving the light can be reduced.

<Variation 4>

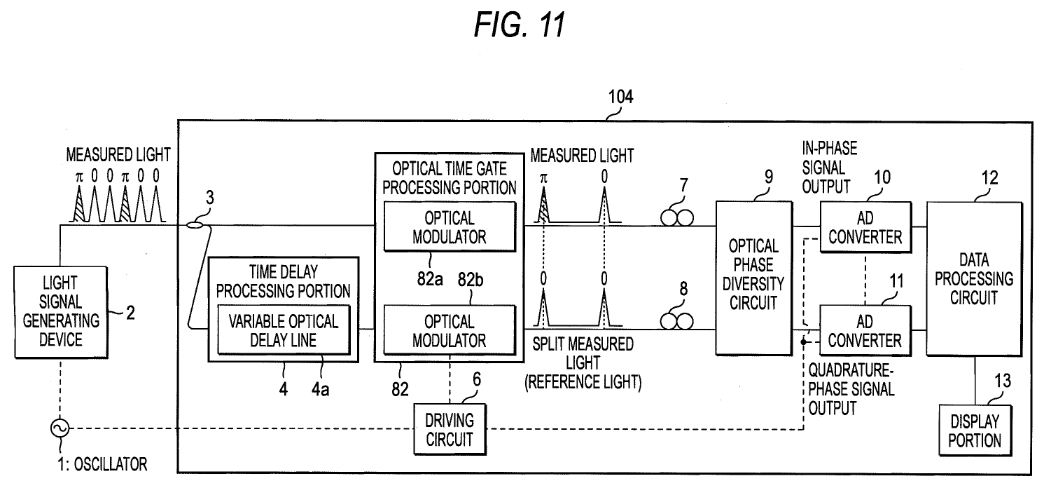

In an optical measuring apparatus 104 in FIG. 11, two optical modulators 82a, 82b are arranged in parallel in an optical time gate processing portion 82, then the process of extracting different bits is applied to two measured lights that are split by the optical branch element 3 respectively, and then the interference signal between different bits can be obtained in the optical phase diversity circuit 9. In this Variation 4, like Embodiment 3, only the light signal necessary for the data acquisition is input into the optical phase diversity circuit 9. Therefore, a noise generated in receiving the light can be reduced.

<Variation 5>

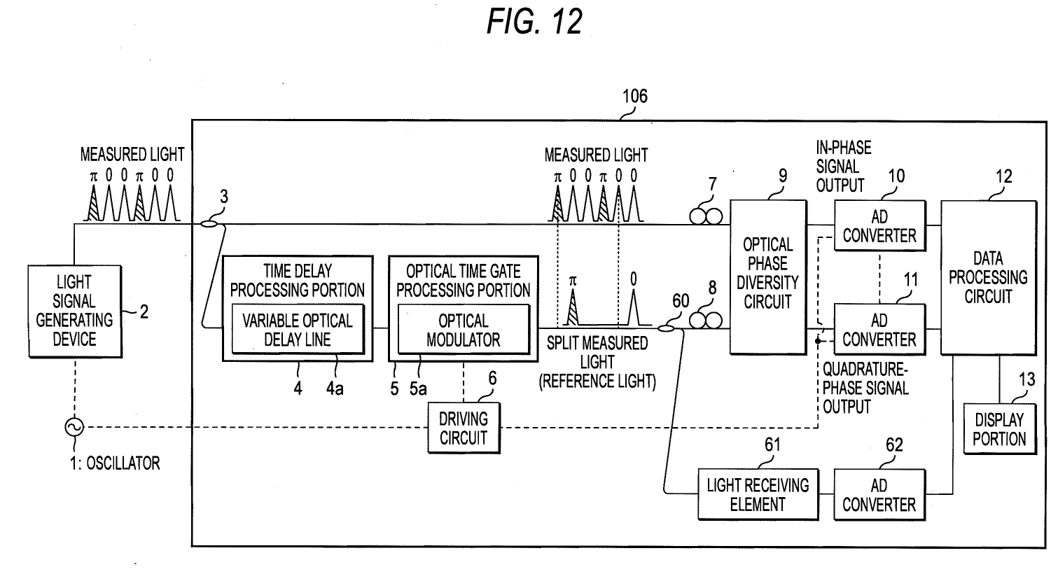

In an optical measuring apparatus 106 shown in FIG. 12, an optical branch element 60 is arranged at the later stage of the optical time gate processing portion 5, then one reference light split by the optical branch element 60 is converted into the electric signal by a light receiving element 61, then this electric signal (the analog signal) is converted into the digital signal by an AD converter 62, and then this digital signal is output to the data processing circuit 12. With this arrangement, an intensity of the reference light is measured separately from the amplitude/phase measurement and is employed in the data processing, and therefore a measuring accuracy can be improved. Also, the modulation signal obtained by adding the digital value to the intensity (amplitude) component of the light signal (for example, the signal modulated by the APSK system) can be measured. In this case, the measuring section of the present invention corresponds to the light receiving element 61 and the AD converter 62. Also, the configuration for measuring the intensity of the reference light is employed in FIG. 12, but the intensity of the measured light may be measured instead of the intensity of the reference light and may be employed in the data processing. That is, any configuration may be employed if the intensity or at least one of the reference light or the measured light is employed in the data processing.

<Variation 6>

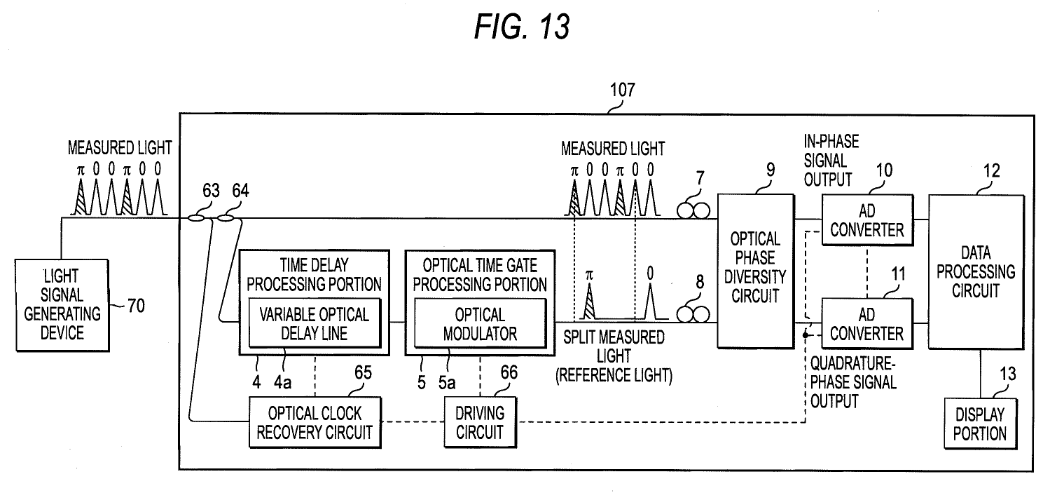

In an optical measuring apparatus 107 shown in FIG. 13, the measured light on which random data are superposed (for example, the light signal modulated by the DPSK system) is generated by a light signal generating device 70, and the generated measured light is split by an optical branch element 63. In an optical clock recovery circuit 65, an electric clock signal that is in synchronism with one measured light split by the optical branch element 63 is generated, and then output to a driving circuit 66. The driving circuit 66 generates a driving signal whose period is longer than a repetitive period of the measured light, based on the electric clock signal that is input from the optical clock recovery circuit 65. This driving circuit 66 drives the optical modulator 5a that the optical time gate processing portion 5 has by the generated driving signal. The other measured light split by the optical branch element 63 is further split by an optical branch element 64, and then the time delay process and the optical time gate process are applied to one of the measured lights split by the optical branch element 64.

In this manner, since the optical measuring apparatus 107 has the optical clock recovery circuit 65, the oscillator for generating the electric clock signal in synchronism with the measured light is not needed. In this case, the light signal used for the clock extraction may be picked up from the later stage of the optical branch element 64.

<Variation 7>

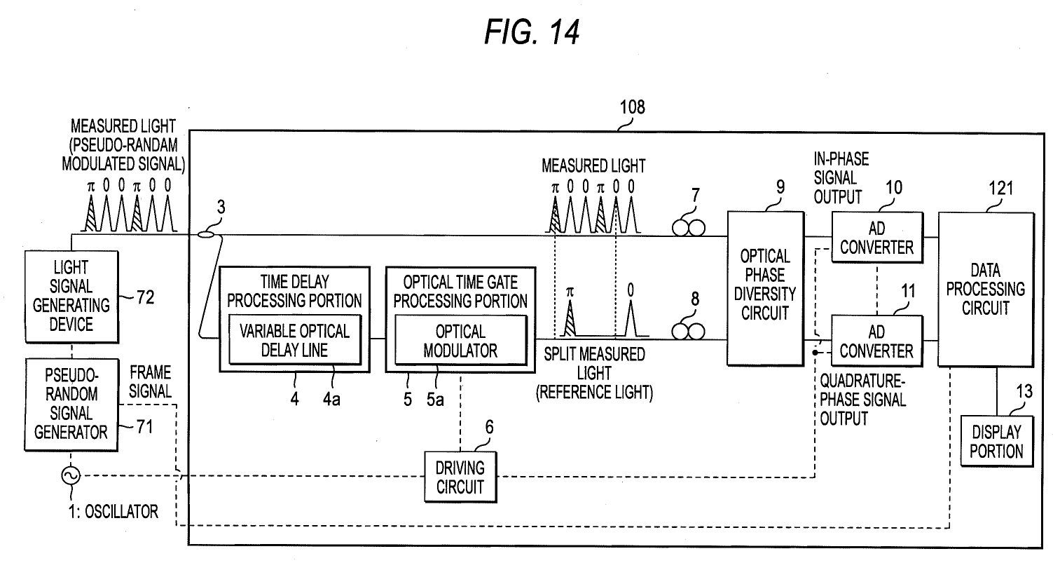

In an optical measuring apparatus 108 shown in FIG. 14, a light signal on which pseudo-random data are superposed (pseudo-random modulation signal) is used as the measured light. In FIG. 14, a pseudo-random signal generator 71 outputs a signal that corresponds to a pseudo-random code (pseudo-random signal) to a light signal generating device 72. Also, the pseudo-random signal generator 71 generates a frame signal that is in synchronism with a repetitive frequency of the pseudo-random code, and outputs this frame signal to a data processing circuit 121 of the optical measuring apparatus 108. The light signal generating device 72 generates the pseudo-random modulation signal as the measured light, based on the pseudo-random signal being input from the pseudo-random signal generator 71.

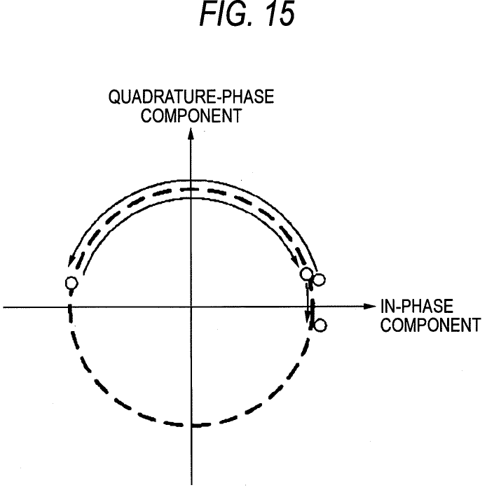

The data processing circuit 121 rearranges the data acquired from the AD converters 10, 11 on a basis of the frame signal input from the pseudo-random signal generator 71, and thus calculates an amount of change of the amplitude and an amount of change of the phase of the measured light every bit. When the display of amplitude/phase distributions is devised in the display portion 13, loci of amplitude and phase changes of the measured light can be displayed, as shown in FIG. 15, or motions of the amplitude and phase changes can be displayed as the dynamic animation.

<Variation 8>

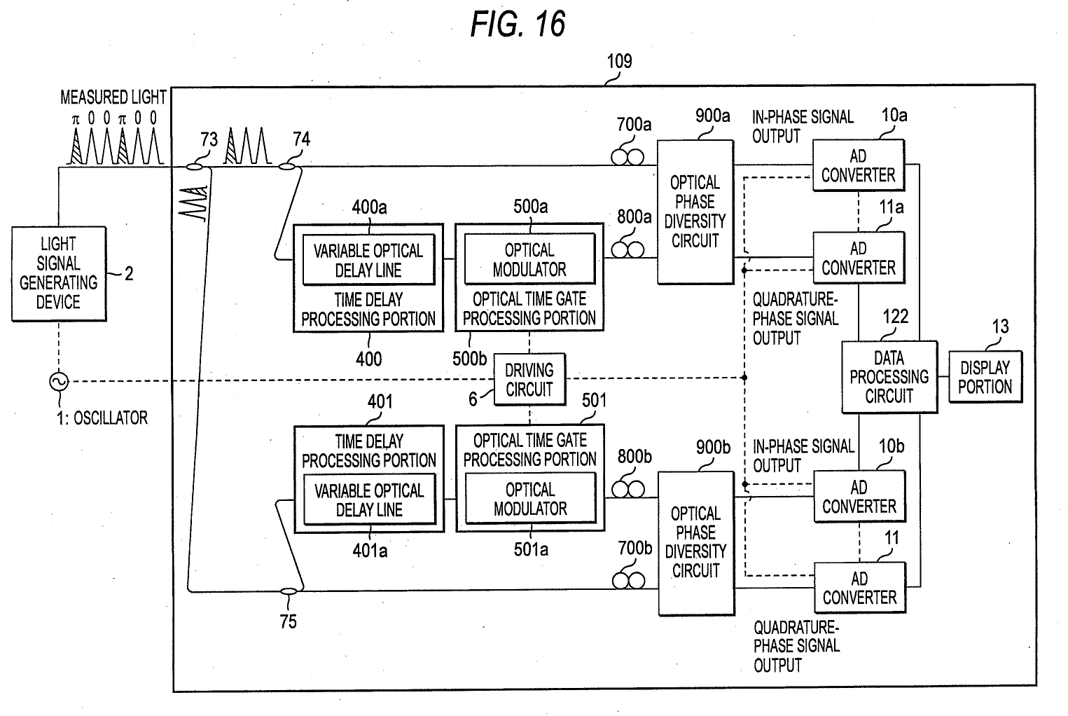

In an optical measuring apparatus 109 shown in FIG. 16, the measured light is separated into two polarization components, which intersect orthogonally with each other, by using a polarization isolating element 73, and then the amplitude measurement and the phase measurement or respective polarization components are made independently on the similar principle of the optical measuring apparatus 100 in FIG. 1. As to one polarization component, the in-phase signal component and the quadrature-phase signal component are derived from one polarization component by using a light branch element 74, a time delay processing portion 400 having a variable optical delay line 400a, an optical time gate processing portion 500b having an optical modulator 500a, polarization controllers 700a, 800a, an optical phase diversity circuit 900a, and AD converters 10a, 11a. Similarly, as to the other polarization component, the in-phase signal component and the quadrature-phase signal component are derived from the other polarization component by using a light branch element 75, a time delay processing portion 401 having a variable optical delay line 401a, an optical time gate processing portion 501 having an optical modulator 501a, polarization controllers 700b, 800b, an optical phase diversity circuit 900b, and AD converters 10b, 11b.

A data processing circuit 122 can calculate a polarization state of the measured light by analyzing the acquired data from the AD converters 10a, 11a, 10b, 11b. Two types of amplitude/phase distributions can be obtained in response to the polarizations on the display portion 13. When the optical measuring apparatus of Variation 8 is applied, the measurement that does not depend on the input polarization state (the polarization diversification) can be carried out.

### Embodiment 2

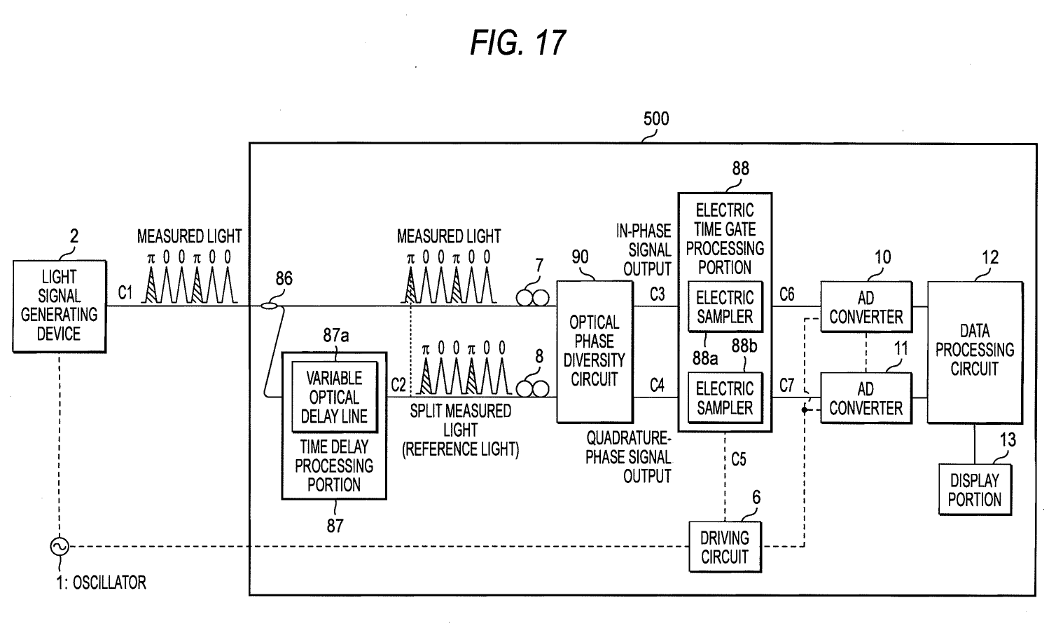

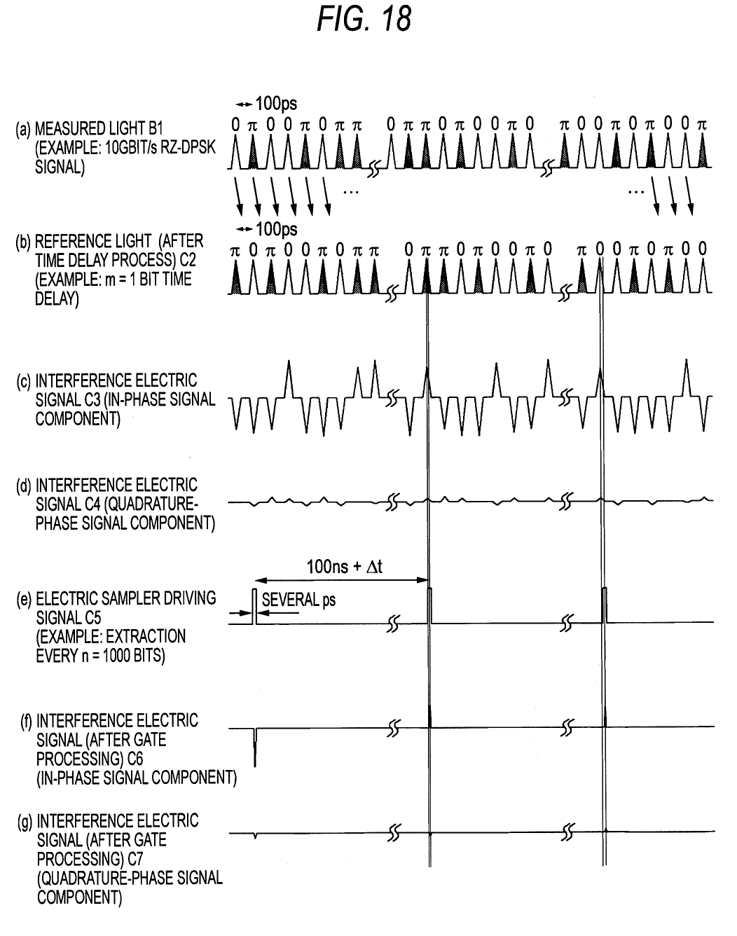

Embodiment 2 of the present invention will be explained with reference to FIG. 17 and FIG. 18 hereunder.

In Embodiment 2, the electric time gate processing portion 88 is employed as shown in FIG. 17 in place of the optical time gate processing portion 5 in Embodiment 1.

An example of an internal configuration of an optical measuring apparatus 500 according to Embodiment 2 of the present invention is shown in FIG. 17. In this case, in Embodiment 2, the same reference symbols are affixed to the same constituent elements as those of the optical measuring apparatus 100 of Embodiment 1. Only different points from the optical measuring apparatus 100 of Embodiment 1 will be explained hereunder.

As shown in FIG. 17, the optical measuring apparatus 500 is constructed by an optical branch element 86, a time delay processing portion 87, the polarization controllers 7, 8, an optical phase diversity circuit 90, an electric time gate processing portion 88, a driving circuit 89, the AD converters 10, 11, the display portion 13, and others.

The optical branch element 86 splits the measured light input from the light signal generating device 2 into two lights. One split light of the measured light will be called the reference light.

The time delay processing portion 87 has a variable optical delay line 87a, and gives a time delay to one measured light split by the optical branch element 86. The time delay processing portion 87 adjusts a delay time of the variable optical delay line 87a such that a relative time difference between the measured light to be input into the optical phase diversity circuit 90 and the reference light is an m bit time (m is an integer).

An internal configuration of the optical phase diversity circuit 90 is similar to that of the optical phase diversity circuit 9 shown in FIG. 2 and in Embodiment 1. But the light receiving element and the differential output circuit that follow up the repetitive frequency of the measured light are employed.

The electric time gate processing portion 88 is constructed by electric samplers 88a, 88b. The electric time gate processing portion 88 extracts the in-phase signal component and the quadrature-phase signal component input from the optical phase diversity circuit 90, while shifting the timing by a phase shifting means (not shown) every n-bit time (n is an integer).

The driving circuit 89 generates a driving signal, whose period is longer than a repetitive period of the measured light, based on the electric clock signal input from the oscillator 1, and then drives the electric samplers 88a, 88b provided to the electric time gate processing portion 88 by the driving signal. Also, the driving circuit 89 outputs the driving signal to the AD converters 10, 11.

A time chart of a measured light C1 generated by the light signal generating device 2, a reference light C2 to which a time delay is given by the time delay processing portion 87, an in-phase signal component C3 of the measured light being output from the optical phase diversity circuit 90, an quadrature-phase signal component C4 of the same, a driving signal C5 output from the driving circuit 89, an in-phase signal component C6 to which the process is applied by the electric time gate processing portion 88, and an quadrature-phase signal component C7 of the same is shown in FIG. 18.

As shown in FIG. 18, the RZ-DPSK signal of 10 Gbit/s (repetitive frequency is 10 GHz) is employed as the measure light C1 (FIG. 18(a)). A relative time difference between the measure light C1 input into the optical phase diversity circuit 90 and the reference light C2 is set to 1 bit time (m=1), 100 ps (FIG. 18(b)). As shown in FIG. 18(c) and FIG. 18(d), the interference signals C3, C4 are obtained as the electric signal by the light receiving element and the differential output circuit in the optical phase diversity circuit 90. These interference signals (the in-phase signal component C3 and the quadrature-phase signal component C4) are extracted (sampled) as the in-phase signal component C6 and the quadrature-phase signal component C7, as shown in FIG. 18(f) and FIG. 18(g), by the electric samplers 88a, 88b that are driven simultaneously by a predetermined driving signal shown in FIG. 18(e).

Like the driving signal shown in FIG. 3(c), a pulse width of the driving signal shown in FIG. 18(e) is set sufficiently shorter (for example, several ps) than 1 bit time (e.g., 100 ps for the measured light of 10 Gbit/s), and also a repetitive period of the same is set to a period different from n-bit time (n is an integer) of the measured light (e.g., 100 ns+Δt). Concretely, the phase of the driving signal is shifted by a predetermined amount Δt (e.g., 1 ps) every predetermined bit time. Accordingly, the in-phase signal component C3 and the quadrature-phase signal component C4 are extracted (sampled) as the in-phase signal component C6 and the quadrature-phase signal component C7 every 1000 bit time (n=1000).

According to the above operation, the interference signal of the measure light between different m-bits are input from the electric time gate processing portion 88 to the AD converters 10, 11 as the in-phase signal component C6 (FIG. 18(f)) and the quadrature-phase signal component C7 (FIG. 18(g), to which the gate processing (the sampling process) was applied in the period that is different from the n-bit time. Then, like Embodiment 1, the data of the in-phase signal output and the quadrature-phase signal output are acquired in synchronism with the signal period, and then an amount of change of the amplitude and an amount of change of the phase of the measured light between different n bit can be obtained sequentially by analyzing the acquired data by means of the data processing circuit 12. Then, the amplitude/phase distributions are formed from the resultant measured values, and then their changes in time are calculated. Accordingly, the observed results contain three-dimensional information of amplitude/phase/time. Three-dimensional distribution display data of amplitude/phase/time formed in this manner and similar to those in FIG. 4 are output to the display portion 13. Therefore, a statistical distribution of an amount of change of the amplitude and an amount of change of the phase of the measured light can be grasped from the variation of plot data of the amplitude/phase distributions, and their change and variation in time can be obtained. As a result, a quality evaluation of the light signal can be made in more detail.

As described above, according to the optical measuring apparatus 500 in Embodiment 2, like Embodiment 1, an amount of change of the amplitude and an amount of change of the phase of the light signal and their changes in time can be measured without use of the local oscillation light (the sampling light).

Also, an amount of change of the amplitude and an amount of change of the phase of the light signal and their changes in time can be measured without use of the optical modulator.

In this event, the description contents in Embodiment 2 can be varied appropriately without departing from a gist of the present invention.

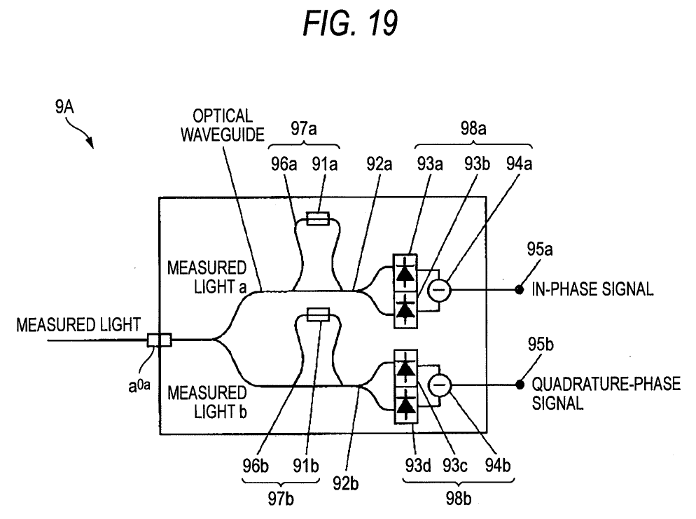

Instead of the time delay processing portion 4 and the optical phase diversity circuit 9 in FIG. 1 and the time delay processing portion 87 and the optical phase diversity circuit 90 in FIG. 17, an element having both functions shown in FIG. 19 can be utilized. In this case, in an element 9A having both functions of the time delay processing portion and the optical phase diversity circuit shown in FIG. 19, the same reference symbols are affixed to the same configurations as the optical phase diversity circuit 9 in FIG. 2. Only difference points from the optical phase diversity circuit 9 in FIG. 2 will be explained hereunder.

In FIG. 19, the element 9A having both functions of the time delay processing portion and the optical phase diversity circuit together is constructed by a measured light input port 90a, phase adjusters 91a, 91b, directional couplers 92a, 92b, light receiving elements 93a, 93b, 93c, 93d, differential output circuits 94a, 94b, an in-phase signal output port 95a, an quadrature-phase signal output port 95b, and delay waveguides 96a, 96b. Also, a delayed interferometer 97a is constructed by the phase adjuster 91a and the delay waveguide 96a. Similarly, a delayed interferometer 97b is constructed by the phase adjuster 91b and the delay waveguide 96b. Also, a differential photodetector 98a is constructed by the light receiving elements 93a, 93b and the differential output circuit 94a. Similarly, a differential photodetector 98b is constructed by the light receiving elements 93c, 93d and the differential output circuit 94b.

The measured light being input via the measured light input port 90a is split into two lights. A measured light a as one split light of the measured light is further split. One measured light being split from the measured light a is guided to the delay waveguide 96a, and then input into the directional coupler 92a via the phase adjuster 91a. The light being guided to the delay waveguide 96a and then input into the directional coupler 92a via the phase adjuster 91a corresponds to the reference light in FIG. 2. Also, the other measured light being split from the measured light a is also input into the directional coupler 92a. The light being split from the measured light a corresponds to the measured light in FIG. 2.

The light input into the directional coupler 92a is split into two lights, and then input into the light receiving elements 93a, 93b respectively. The input light signal is converted into the electric signal by the light receiving elements 93a, 93b respectively. At this time, since the measured light and the reference light both input into the light receiving element 93a interfere with each other, the interference signal (containing a DC component) corresponding to a phase difference φ between them is output from the light receiving element 93a. The similar interference signal is obtained by the light receiving element 93b. But this interference signal has an intensity distribution that is inverted from the output signal of the light receiving element 93a on account of the characteristic of the directional coupler 92a.

The differential output circuit 94a calculates a difference between the output signals of two light receiving elements 93a, 93b, and outputs this difference. Accordingly, the DC component is removed from two interference signals, and only the interference signal corresponding to a phase difference φ is output from the in-phase signal output port 95a as the electric signal.

In contrast, a measured light b as the other split light of the measured light is further split. One measured light being split from the measured light b is guided to the delay waveguide 96b, and then input into the directional coupler 92b after a phase difference of π/2 is added by the phase adjuster 91b. The light being guided to the delay waveguide 96b and then input into the directional coupler 92b after the phase difference of π/2 is added by the phase adjuster 91b corresponds to the reference light in FIG. 2. Also, the other measured light being split from the measured light b is also input into the directional coupler 92b. The other measured light being split from the measured light b corresponds to the measured light in FIG. 2.

The light input into the directional coupler 92b is split into two lights, and then input into the light receiving elements 93c, 93d respectively. From the light being input into the light receiving elements 93c, 93d, the interference signal corresponding to a relative phase difference φ+π/2 between them is obtained by the differential output circuit 94b as the electric signal, and is output from the quadrature-phase signal output port 95b.

The output signal from the differential output circuit 94a and the output signal from the differential output circuit 94b give the signal components that intersects orthogonally with the optical phase of the measured light mutually. Therefore, one signal component is acquired as the in-phase signal component and the other signal component is acquired as the quadrature-phase signal, then these components are converted into the digital signals, and then the data processing is made in the data processing circuit 12.

Also, in Embodiment 2, the internal configuration shown in FIG. 2, FIG. 5 to FIG. 7 can also be applied as the optical phase diversity circuit 90. Also, in the optical measuring apparatus 500 in Embodiment 2, the configuration shown in Variations 5 to 8 in Embodiment 1 can be applied.

### Embodiment 3

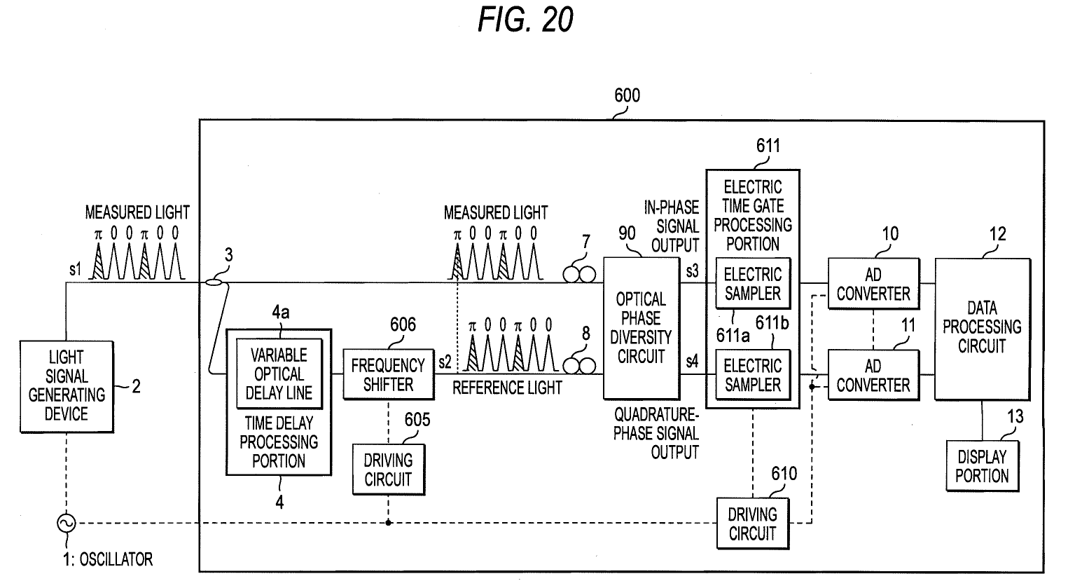

Embodiment 3 of the present invention will be explained with reference to FIG. 20 to FIG. 26 hereunder.

In Embodiment 3, the frequency shifter is employed.

In the approach in Embodiment 2, since the delayed self-homodyne approach is employed, the electric signal (the in-phase signal component and the quadrature-phase signal component) obtained by the optical phase diversity circuit 90 after the photoelectric conversion contains the direct current (DC) component. When the measured light is seldom subject to the modulation and comes closer to the constant signal, such measured light contains a larger amount of low frequency component near the DC. Therefore, in order to execute the precise measurement, the components having the good low-frequency characteristic (to the DC component) are needed in the electric circuits subsequent to the optical phase diversity circuit 90. For example, when the electric signal from the optical phase diversity circuit 90 should be amplified, e.g., an intensity of the measured light is weak, or the like, it may be considered that the amplifier (AMP) should be inserted in the later stage of the optical phase diversity circuit 90. However, the amplifier that will be utilized in the system shown in Embodiment 2 intends mainly to amplify the high frequency component. Thus, it is difficult for such amplifier to amplify the signal of the low frequency component containing the DC component.

Therefore, not the delayed self-homodyne approach but the delayed self-heterodyne approach is used in the approach of measuring an amount of change of the amplitude and an amount of change of the phase without the local oscillation light, and as a result an approach that makes it possible to use the components whose low frequency characteristic is poor (which does not correspond to the DC component) in the electric circuit will be shown in present Embodiment 3.

An example of an internal configuration of an optical measuring apparatus 600 according to Embodiment 3 and the oscillator 1 and the light signal generating device 2 are shown in FIG. 20. In Embodiment 3, the same reference symbols are affixed to the same constituent elements as those in the optical measuring apparatus 100 of Embodiment 1. Merely different points from the optical measuring apparatus 100 of Embodiment 1 will be explained hereunder.

The oscillator 1 outputs the clock signal, which is synchronized with the measured light generated by the light signal generating device 2, to the light signal generating device 2 and a driving circuit 605 and a driving circuit 610 of the optical measuring apparatus 600.

As shown in FIG. 20, the optical measuring apparatus 600 is constructed by the optical branch element 3, the time delay processing portion 4, a driving circuit 605, a frequency shifter 606, the polarization controllers 7,8, an optical phase diversity circuit 90, the driving circuit 610, an electric time gate processing portion 611, the AD converters 10, 11, the data processing circuit 12, and the display portion 13.

The frequency shifter 606 shifts the optical carrier frequency of either of the measured light and the reference light. The acoust-optic element, or the like may be considered as the frequency shifter 606. The driving circuit 605 controls a shift amount Fs such that Fs=fc/k (k is an integer) is given by frequency-dividing an electric clock signal fc input from the oscillator 1. At this time, the optical carrier frequency after the light passes through the frequency shifter 606 becomes ν₀−Fs wherein ν₀ is an optical carrier frequency of the light before the light passes through the frequency shifter 606. As the electric components (the light receiving element, and the like) used in the optical phase diversity circuit 90, the component that is able to follow up a repetitive frequency of the measured light is employed. The electric time gate processing portion 611 is constructed by electric samplers 611a, 611b, and executes the process of extracting the in-phase signal component and the quadrature-phase signal component input from the optical phase diversity circuit 90 every n bit time (n is an integer). The driving circuit 610 generates the driving signal whose period is longer than the repetitive period of the measured light, based on the electric clock input from the oscillator 1, and drives the electric samplers 611a, 611b in the electric time gate processing portion 611 by the driving signal. Also, the driving circuit 610 outputs the driving signal to the AD converters 10, 11.

The optoelectric field Esig(t) of the measured light input into the optical phase diversity circuit 90 and the optoelectric field Eref(t) of the reference light are represented by Equation (5) and Equation (6) respectively.

[Formula 5]

E_{sig}(t)=s(t)exp [−i(2πν₀t+φ(t))] (5)

[Formula 6]

E_{ref}(t)=s(t−T)exp [−i(2π(ν_{O}−F_{S})(t−T)+φ(t−T))] (6)

where s(t) denotes a change of the amplitude of the measured Light in time, and T denotes an amount of delay given by the time delay processing portion 4. Also, ν₀ is an optical carrier frequency of the measured light, and Fs is an amount of shift given by the frequency shifter 606. Also, φ(t) denotes an amount of phase modulation of the measured light, and has a different value every signal bit. Then, while using the measured light and the reference light given by Equation (5) and Equation (6), the in-phase signal component I(t) and the quadrature-phase signal component Q(t) output from the optical phase diversity circuit 90 are represented by Equation (7) and Equation (8) respectively.

[Formula 7]

I(t)∝s(t)·s(t−T)cos(2πFₛt+φ(t)−φ(t−T)+ψ) (7)

[Formula 8]

Q(t)∝s(t)·s(t−T)sin(2πFₛt+φ(t)−φ(t−T)+ψ) (8)

where ψ is a constant given by ψ=2π (ν₀−Fs)T. From Equation (7) and Equation (8), the in-phase signal component I(t) and the quadrature-phase signal component Q(t) are obtained as the signal that oscillates at an amount of shift Fs given by the frequency shifter 606, regardless of an amount of phase shift φ(t)−φ(t−T) of the measured light. From the above, even when the measured light is the signal that is seldom subject to the modulation and comes closer to the constant signal (contains a plenty of low frequency components), the electric signal being output from the optical phase diversity circuit 90 is obtained as the signal having the frequency component that is higher by an amount of shift Fs.

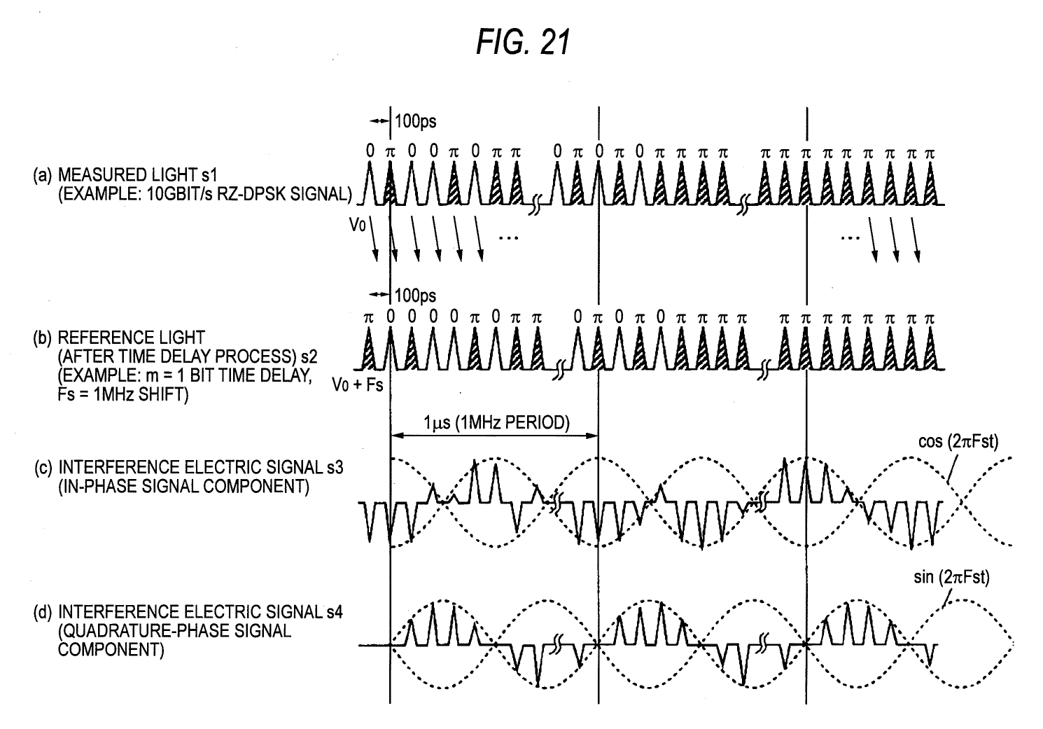

A time chart (schematic view) of a measured light s1 generated by the light signal generating device 2, a reference light s2 that passed through the time delay processing portion 4 and the frequency shifter 606, an in-phase signal component s3 output from the optical phase diversity circuit 90 after the photoelectric conversion, and an quadrature-phase signal component s4 of the same is shown in FIG. 21. As shown in FIG. 21, the RZ-DPSK signal of 10 Gbit/s (the repetitive frequency 10 GHz) is used as the measured light s1 (FIG. 21(a)), and a relative time difference between the measured light s1 and the reference light s2 input into the optical phase diversity circuit 90 is set to 1 bit time (m−1), 100 ps (FIG. 21(b)). At this time, when the electric clock signal is set to 10 GHz (fc=10 GHz) and a frequency dividing ratio used in the driving circuit 605 is set to 10000 (k=10000), an optical carrier frequency of the reference light is shifted by 1 MHz (Fs=1 MHz). From the above, the in-phase signal component s3 output from the optical phase diversity circuit 90 (FIG. 21(c)) and the quadrature-phase signal component s4 of the same (FIG. 21(d)) are the oscillation signal responding to the cosine (sine) change of 1 MHz and the phase change of the measured signal. When the electric samplers 11a, 11b are oscillated at a repetitive frequency of 10 MHz (100 ns interval) with respect to the in-phase signal component and the quadrature-phase signal component, respective signals are extracted (sampled) every 1000 bit time (n=1000).

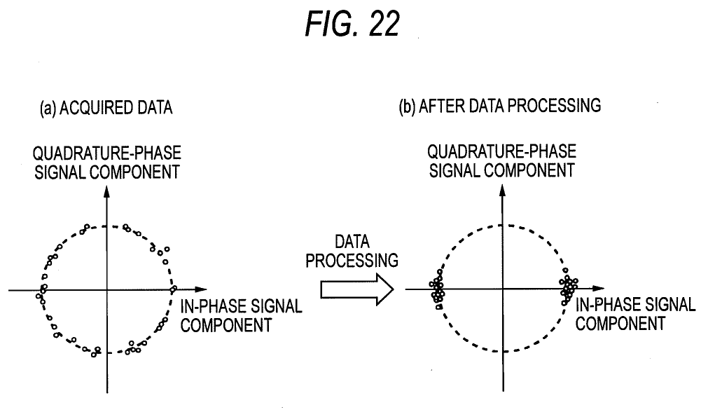

According to the above operation, the interference signal between different m bits of the measured light is obtained sequentially from the electric time gate processing portion 611 in an operation period (n bit time) of the electric samplers 11a, 11b, while causing the cosine (sine) oscillation at the frequency Fs. Then, the data of the in-phase signal output and the quadrature-phase signal output are acquired in synchronism with the signal period, and the acquired data are analyzed by the data processing circuit 12. At this time, when the data of the in-phase signal component and the data of the quadrature-phase signal component are plotted on the x coordinate and the y coordinate respectively, the distribution that rotates at a predetermined angular velocity corresponding to the frequency Fs is obtained. Since an amount of shift Fs given by the frequency shifter 606 has already been known, desired amplitude/phase distributions can be acquired by processing the acquired data, as shown in FIG. 22. The resultant distribution can be displayed on the display portion 13, and statistical distributions of an amount of change of the amplitude and an amount of change of the phase of the measured light can be derived from the dispersion of the plotted data in the amplitude/phase distributions. As a result, a quality evaluation of the light signal can be made.

As described above, according to the optical measuring apparatus 600 of Embodiment 3, like Embodiment 1, an amount of change of the amplitude and an amount of change of the phase of the measured light can be measured without use of the local oscillation light (the sampling light).

Also, according to the optical measuring apparatus 600 of Embodiment 3, since the electric signal involving the cosine (sine) oscillation can be obtained steadily from the optical phase diversity circuit 90, the components whose low frequency characteristic is poor (which does not correspond to the DC component) can be used in the electric circuit. Also, since a choice of the available components is widened, improvement of the performance such as a measuring accuracy, a measuring sensitivity, or the like can be expected.

In this event, the description contents in Embodiment 3 can be varied appropriately without departing from a gist of the present invention.

For example, in the optical measuring apparatus 600, the time delay processing portion 4 and the frequency shifter 606 may be arranged on either route that is split by the optical branch element 3.

Also, in the optical measuring apparatus 600, the optical time gate processing portions 5, 56 may be employed instead of the electric time gate processing portion 611. At this time, the optical time gate processing portions 5, 56 are arranged in the position shown in FIG. 1 and FIG. 12.

Also, like the case of Embodiment 2, the element having both functions together, as shown in FIG. 19, can be utilized instead of the time delay processing portion and the optical phase diversity circuit.

Also, in Embodiment 3, the internal configuration shown in FIG. 2, FIG. 5 to FIG. 7 can be applied as the optical phase diversity circuit 90. In addition, in the optical measuring apparatus 600 of Embodiment 3, the configuration shown in Variations 5 to 8 of Embodiment 1 can be applied.

Variations of the optical measuring apparatus 600 of Embodiment 3 will be explained hereunder.

<Variation 1>

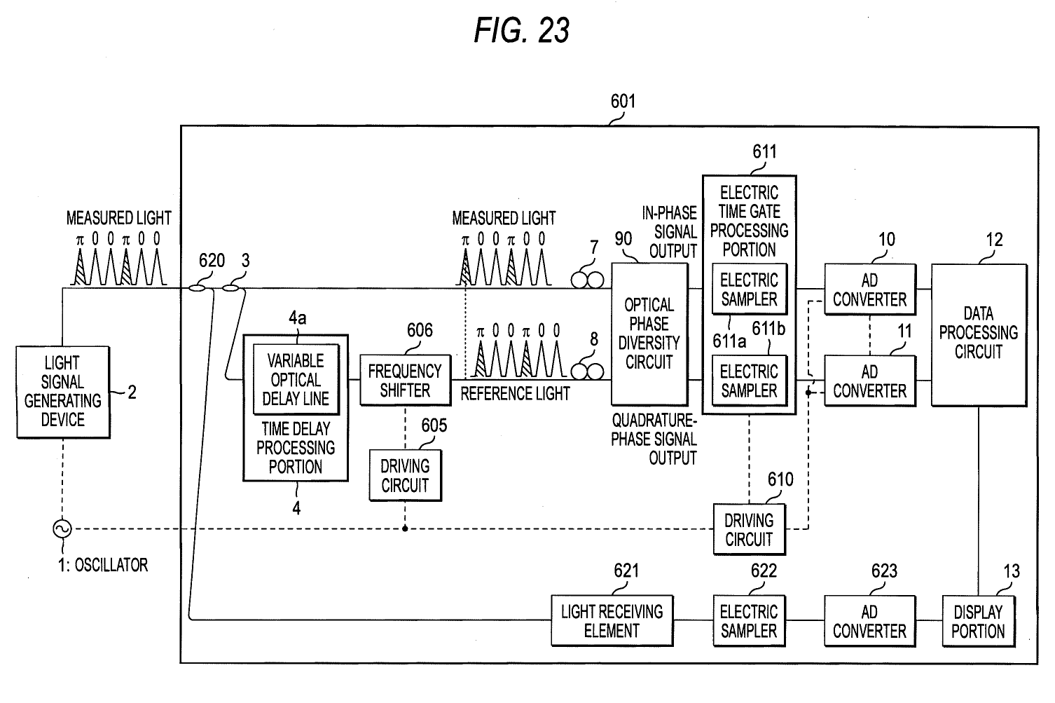

In an optical measuring apparatus 601 shown in FIG. 23, an optical branch element 620 is provided, one measured light split by the optical branch element 620 is converted into the electric signal by a light receiving element 621, this electric signal is converted into a digital signal by an electric sampler 622 and an AD converter 623, and this digital signal is output to the data processing circuit 12. With this arrangement, an intensity of the measured light is measured separately (from the amplitude/phase measurement) by using the light receiving element 621, the electric sampler 622 and an AD converter 623, and then used in the data processing, and therefore improvement of a measuring accuracy can be attained. Also, a modulation signal in which the digital value is added to the intensity (amplitude) component of the light signal (e.g., a signal modulated by the APSK system) can be measured. In this case, the measured light or the reference light detected at the later stage of the optical branch element 3 may be employed in measuring the intensity of the measured light.

<Variation 2>

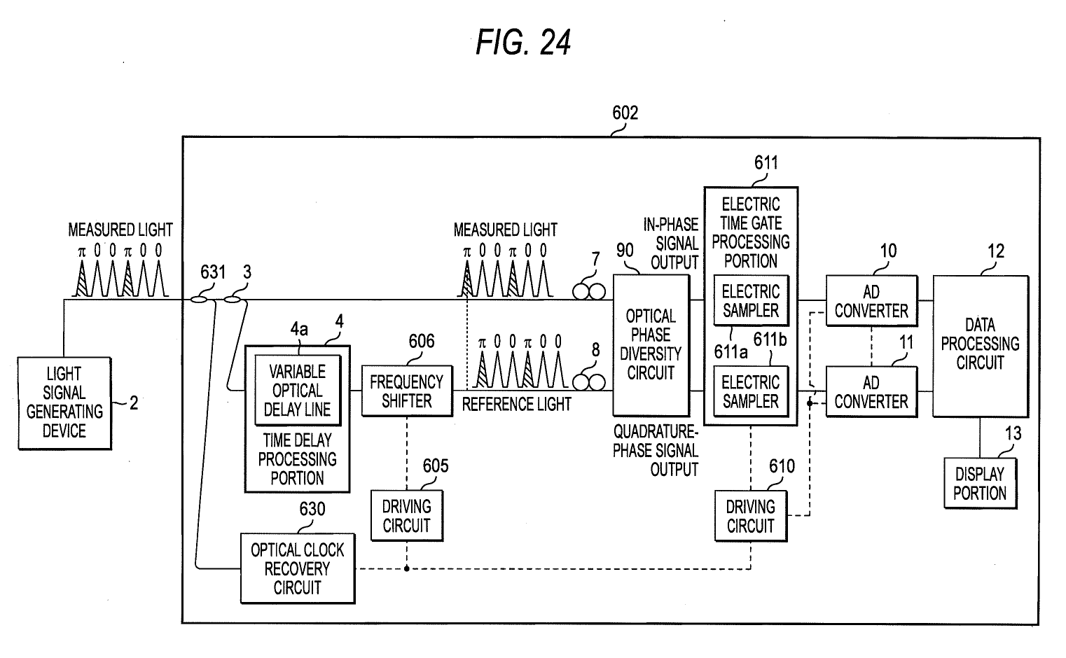

In an optical measuring apparatus 602 shown in FIG. 24, an optical clock recovery circuit 630 is used instead of the oscillator 1 shown in FIG. 20. The optical clock recovery circuit 630 generates the electric clock signal in synchronism with the measured light that is split by an electric branch element, and outputs this signal to a driving circuit 605 and the driving circuit 610. Because the optical clock recovery circuit 630 is provided, the oscillator for generating the electric clock signal in synchronism with the measured light is not needed. In this case, the light signal used in the clock recovery may be picked up from the later stage of the optical branch element 3. Also, the electric clock recovery circuit for generating the electric clock signal may be arranged at the later stage of the optical phase diversity circuit 90, instead of the optical clock recovery circuit 630.

<Variation 3>

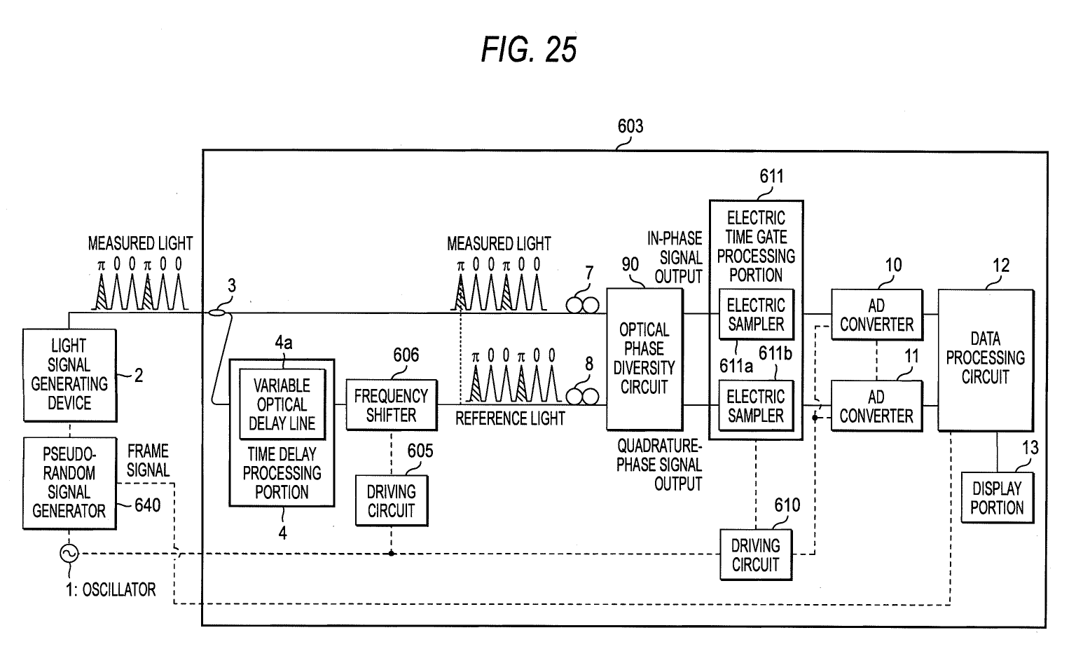

In an optical measuring apparatus 603 shown in FIG. 25, the light signal on which pseudo-random data are superposed (a pseudo-random modulation signal) is employed as the measured light. In FIG. 25, a pseudo-random signal generator 640 outputs a signal corresponding to a pseudo-random code (a pseudo-random signal) to the light signal generating device 2. Also, the pseudo-random signal generator 640 generates a frame signal in synchronism with the repetitive frequency of the pseudo-random code, and outputs this frame signal to the data processing circuit 12 of the optical measuring apparatus 603. The light signal generating device 2 generates a pseudo-random modulation signal as the measured light, based on the pseudo-random signal output from the pseudo-random signal generator 640. The data processing circuit 12 calculates an amount of change of the amplitude and an amount of change of the phase of the measured light every bit by rearranging the acquired data on a basis of the frame signal input from the pseudo-random signal generator 640. The display portion 13 can display loci of the amplitude change and the phase change of the measured light by devising the display of the amplitude/phase distributions, and display dynamically its movement.

Variation 4>

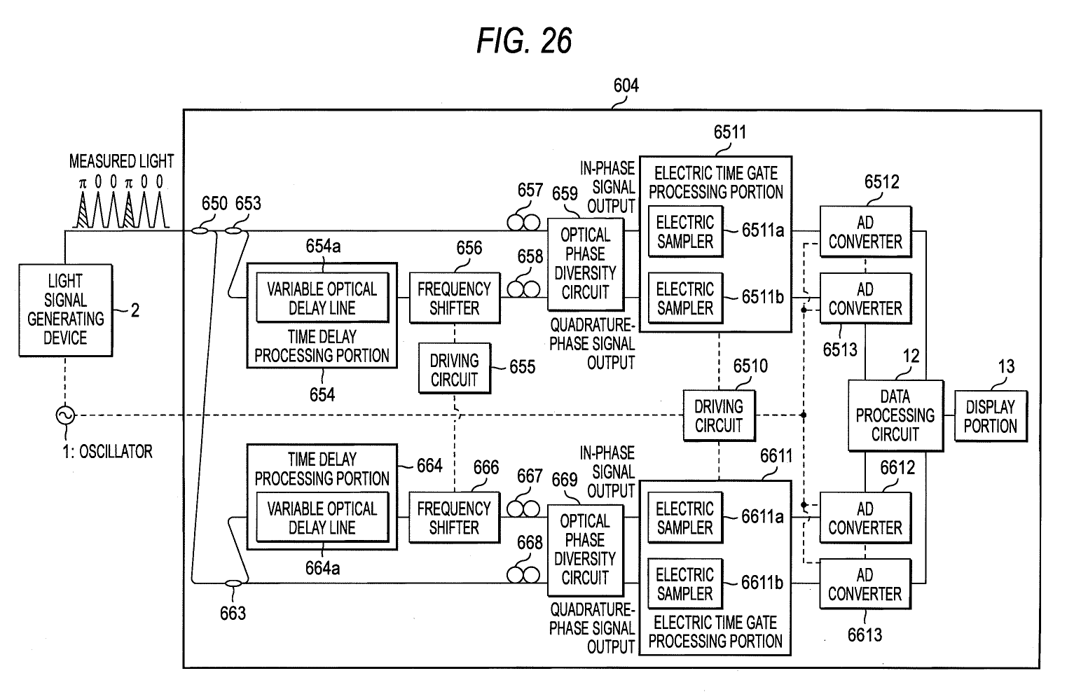

In an optical measuring apparatus 604 shown in FIG. 26, the measured light is separated into two polarized components that intersect orthogonally with each other, by using a polarization isolating element 650, and then an amount of change of the amplitude and an amount of change of the phase are measured independently from respective polarized components on the principle similar to the optical measuring apparatus 600 in FIG. 20. As to one polarized component, the in-phase signal component and the quadrature-phase signal component of the polarized component are obtained by using an optical branch element 653, a time delay processing portion 654 having a variable optical delay line 654a, a driving circuit 655, a frequency shifter 656, polarization controllers 657, 658, an optical phase diversity circuit 659, a driving circuit 6510, an electric time gate processing portion 6511 having electric sampler 6511a, 6511b, and AD converters 6512, 6513. Similarly, as to the other polarized component, the in-phase signal component and the quadrature-phase signal component of the polarized component are obtained by using an optical branch element 663, a time delay processing portion 664 having a variable optical delay line 664a, a frequency shifter 666, polarization controllers 667, 668, an optical phase diversity circuit 669, an electric time gate processing portion 6611 having electric samplers 6611a, 6611b, and AD converters 6612, 6613. The data processing circuit 12 can calculate a polarized condition of the measure light by analyzing the acquired data from the AD converters 6512, 6513, 6612, 6613. The display portion 13 can obtain two types of amplitude/phase distributions corresponding to the polarization. The measurement that does not depend on the input polarization state (the polarization diversification) can be carried out.

In this event, the description contents in above embodiments can be varied appropriately without departing from a gist of the present invention.

For example, in the optical measuring apparatus in respective embodiments, a configuration in which the optical time gate processing portion and the electric time gate processing portion are not used may be employed.

What is claimed is:

1. An optical measuring apparatus, comprising:
an optical branch element for splitting a measured light into plural lights;
a time delay processing portion for giving a predetermined time delay to one split light of the measured light;
an optical phase diversity circuit for outputting an in-phase signal component and an quadrature-phase signal component of the measured light by virtue of an interference between the measured light and a reference light between which a relative time difference corresponds to a time give by the time delay, while using other split light of the measured light or the measured light to which a process is applied by the time delay processing portion as the reference light;
a data processing circuit for calculating at least one of an amount of change of an amplitude and an amount of change of a phase of the measured light, based on the in-phase signal component and the quadrature-phase signal component; and
an optical time gate processing portion or an electric time gate processing portion provided on a route extending from the optical branch element to the data processing circuit, for extracting at least one of split lights of the measured light every predetermined bit time while shifting a timing;
wherein changes of amplitude/phase distributions in time are measured.

2. An optical measuring apparatus according to claim 1, further comprising:
a frequency shifter for shifting an optical carrier frequency of one split light of the measured light.

3. An optical measuring apparatus according to claim 1, further comprising:
an optical clock recovery circuit for generating a clock signal in synchronism with the measured light.

4. An optical measuring apparatus according to claim 1, wherein a light signal on which a pseudo-random code is superposed is used as the measured light, and
the data processing circuit executes a data processing by using a frame signal that is synchronized with a repetitive frequency of the pseudo-random code.

5. An optical measuring apparatus according to claim 1, further comprising:
a polarization isolating element for separating the measured light into a plurality of polarization components that intersect orthogonally with each other;
wherein processes made by the optical branch element, the time delay processing portion, and the optical phase diversity circuit are applied to respective polarization components that are separated by the polarization isolating element.

6. An optical measuring apparatus according to claim 1, further comprising:
a measuring section for measuring an intensity of at least one of the measured light and the reference light.

7. An optical measuring apparatus according to claim 1, further comprising:
a display portion for displaying amplitude/phase distributions of the measured light, based on a processed result of the data processing circuit.

8. An optical measuring apparatus according to claim 2, further comprising:
an optical clock recovery circuit for generating a clock signal in synchronism with the measured light.

9. An optical measuring apparatus according to claim 2, wherein a light signal on which a pseudo-random code is superposed is used as the measured light, and
the data processing circuit executes a data processing by using a frame signal that is synchronized with a repetitive frequency of the pseudo-random code.

10. An optical measuring apparatus according to claim 2, further comprising:
a polarization isolating element for separating the measured light into a plurality of polarization components that intersect orthogonally with each other;
wherein processes made by the optical branch element, the time delay processing portion, and the optical phase diversity circuit are applied to respective polarization components that are separated by the polarization isolating element.

11. An optical measuring apparatus according to claim 2, further comprising:
a measuring section for measuring an intensity of at least one of the measured light and the reference light.

12. An optical measuring apparatus according to claim 2, further comprising:
a display portion for displaying amplitude/phase distributions of the measured light, based on a processed result of the data processing circuit.

13. An optical measuring method, comprising steps of:
splitting a measured light into plural lights;
giving a predetermined time delay to one split light of the measured light;
outputting an in-phase signal component and an quadrature-phase signal component of the measured light by virtue of an interference between the measured light and a reference light between which a relative time difference corresponds to a time give by the time delay, while using other split light of the measured light or the measured light to which a process is applied by the time delay processing portion as the reference light;
calculating at least one of an amount of change of an amplitude and an amount of change of a phase of the measured light, based on the in-phase signal component and the quadrature-phase signal component; and
measuring changes of amplitude/phase distributions in time by extracting at least one of split lights of the measured light every predetermined bit time while shifting a timing.
